(19) United States
(12) Patent Application Publication
(10) Pub. No.: US 2016/0110773 A1
(43) Pub. Date: Apr. 21, 2016

(54) SYSTEMS AND METHODS FOR STRUCTURED VALUE PROPOSITIONS

(71) Applicant: The Travelers Indemnity Company, Hartford, CT (US)

(72) Inventors: Jeffrey J. Lamo, Wethersfield, CT (US); William J. Curtis, Avon, CT (US); Sean D. Martin, Portland, OR (US)

(21) Appl. No.: 14/976,329

(22) Filed: Dec. 21, 2015

Related U.S. Application Data
(63) Continuation of application No. 14/137,998, filed on Dec. 20, 2013, now abandoned.
(60) Provisional application No. 61/740,899, filed on Dec. 21, 2012.

(51) Int. Cl. G06Q 30/02; G06F 3/0488; G06Q 40/08

(52) U.S. Cl. CPC G06Q 30/0269; G06Q 40/08; G06F 3/0488

(57) ABSTRACT

Systems, apparatus, interfaces, methods, and articles of manufacture that provide for structured value proposition objects.

### CROSS-REFERENCE TO RELATED APPLICATIONS

The present application claims benefit and priority to, and is a Continuation of, U.S. patent application Ser. No. 14/137,998 filed on Dec. 20, 2013 and titled “SYSTEMS AND METHODS FOR STRUCTURED VALUE PROPOSITIONS”, which itself is a non-provisional of, and claims benefit and priority under 35 U.S.C. §119(e) to, U.S. Provisional Patent Application No. 61/740,899 filed on Dec. 21, 2012 and titled “SYSTEMS AND METHODS FOR STRUCTURED VALUE PROPOSITIONS”, the entirety of each of which is hereby incorporated by reference herein.

### BACKGROUND

In many sales contexts, it is important to present potential customers with the best marketing message available to maximize potential sales of products or services. Yet, despite the vast resources and time spent attempting to achieve such a goal, marketing efforts in competitive sales environments, particularly where competition is driven by non-price factors, have failed to effectuate desired results.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a block diagram of a system according to some embodiments;

FIG. 3 is a block diagram of a conventional system;

FIG. 4A, FIG. 4B, and FIG. 4C are block diagrams of a system according to some embodiments;

FIG. 5 is a block diagram of a system according to some embodiments;

FIG. 6 is a flow diagram of a method according to some embodiments;

FIG. 7 is a flow diagram of a method according to some embodiments;

FIG. 8A, FIG. 8B, FIG. 8C, FIG. 8D, FIG. 8E, and FIG. 8F are diagrams of example value proposition objects according to some embodiments;

FIG. 9 is a block diagram of an apparatus according to some embodiments; and

FIG. 10A, FIG. 10B, FIG. 10C, FIG. 10D, and FIG. 10E are perspective diagrams of exemplary data storage devices according to some embodiments.

### DETAILED DESCRIPTION

Embodiments described herein are descriptive of systems, apparatus, methods, interfaces, and articles of manufacture for structured value proposition objects. In some embodiments, for example, sales, marketing, survey, competitive intelligence, and/or other data may be analyzed to determine which (and/or which combination of) marketing objects and/or media items to present to an agent, broker, and/or customer. Various available media items and/or marketing objects may be sorted, filtered, tagged, ranked, weighted, scored, and/or otherwise processed to determine which such items may be desirable to present as part of a sales and/or marketing effort.

It may be beneficial, for example, in the context of insurance marketing and/or sales, to target and/or customize marketing and/or sales objects for specific industries, regions, and/or customers. Insurance products may generally include any type of insurance products or services, including, but not limited to, property and casualty insurance (including, but not limited to, business/commercial insurance, personal insurance, auto/motor, watercraft, aircraft, spacecraft, worker's compensation, general liability, professional, D&O, E&O, employer liability, business torts, surety and fidelity bonds, product liability, or any other type of insurance coverage), risk control services, risk management information services, and/or claim services. According to some embodiments, the marketing and/or sales efforts may comprise efforts in industries other than insurance, such as automobile sales, construction bidding (commercial, municipal, and/or residential), and/or electronic product sales (e.g., smart phones, computers, and/or televisions). In some embodiments, the marketing and/or sales objects that are analyzed, targeted, and/or customized may comprise one or more value proposition objects.

As utilized herein, the term “value proposition object” may generally refer to any quantity and/or configuration of marketing and/or sales objects that are descriptive of one or more non-price variables, parameters, and/or metrics associated with a product and/or service. In some embodiments, a value proposition object may comprise and/or be descriptive of, in addition to non-price variables, parameters, and/or metrics, one or more price variables, parameters, and/or metrics. Value proposition objects may comprise hard-copy objects such as printed marketing and/or sales materials/collateral (e.g., signage, billboards, handouts, and/or models) and/or electronic objects such as mobile device applications, web interfaces, web pages, and/or electronic files (e.g., various word processing, presentation, and/or spreadsheet files). In the context of marketing and/or sales of insurance and/or underwriting products, for example, a value proposition object may comprise an insurance product sales presentation, sales presentation application (e.g., a smart phone and/or tablet application), sales presentation Application Program Interface (API), sales presentation Graphical User Interface (GUI), sales presentation talking points, etc. In some embodiments, a value proposition object may comprise a plurality of media items and/or objects.

A value proposition object may comprise, for example, a document and/or sign comprising one or more paragraphs of text, one or more images, and/or one or more graphics, trademarks, etc. Media items that define and/or make-up various value proposition objects may include, for example, but are not limited to: (i) paragraphs of text, (ii) text phrases, (iii) grammatical patterns, (iv) words, (v) parameters, (vi) metrics, (vii) formulas, (viii) calculations, (ix) pictures, (x) images, (xi) graphics, (xii) video, (xiii) audio, and/or combinations thereof. In accordance with embodiments herein, a “structured value proposition object” may generally comprise a value proposition object comprised of media items selected, targeted, and/or customized based on one or more particular sales and/or marketing objectives (e.g., based on a particular customer, industry, geography, agent, and/or broker).

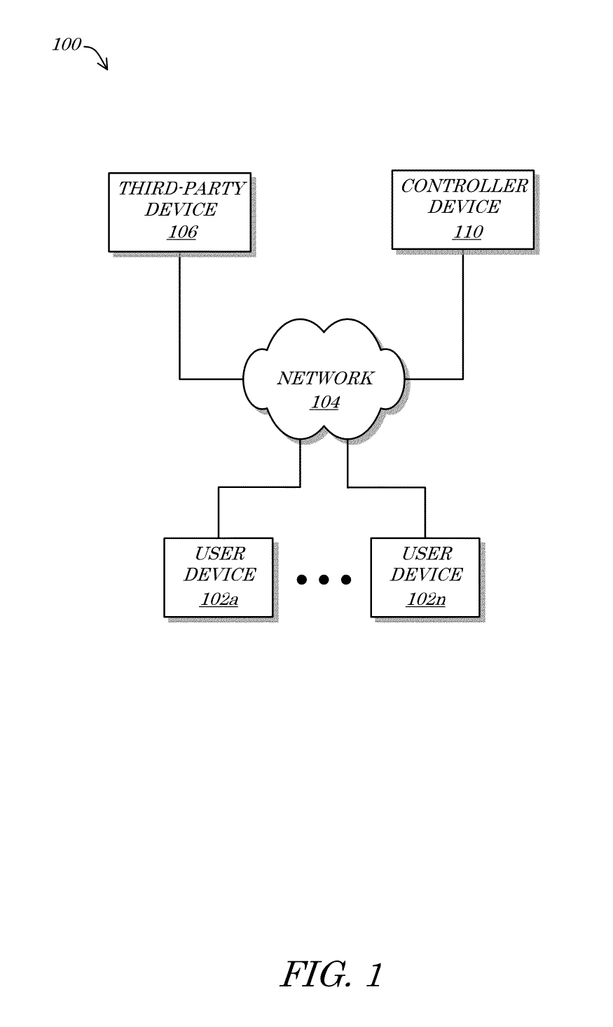

Referring first to FIG. 1, a block diagram of a system 100 according to some embodiments is shown. In some embodiments, the system 100 may comprise a plurality of user devices 102a-n, a network 104, a third-party device 106, and/or a controller device 110. As depicted in FIG. 1, any or all of the devices 102a-n, 106, 110 (or any combinations thereof) may be in communication via the network 104. In some embodiments, the system 100 may be utilized to provide (and/or receive) value proposition objects and/or media items, analyze and/or process such value proposition items and/or media items, and/or construct (and/or facilitate the contrition of) one or more structured value proposition objects. The controller device 110 may, for example, interface with one or more of the user devices 102a-n and/or the third-party device 106 to acquire, gather, aggregate, process, and/or utilize value proposition object and/or media item data and/or other data or metrics in accordance with embodiments described herein.

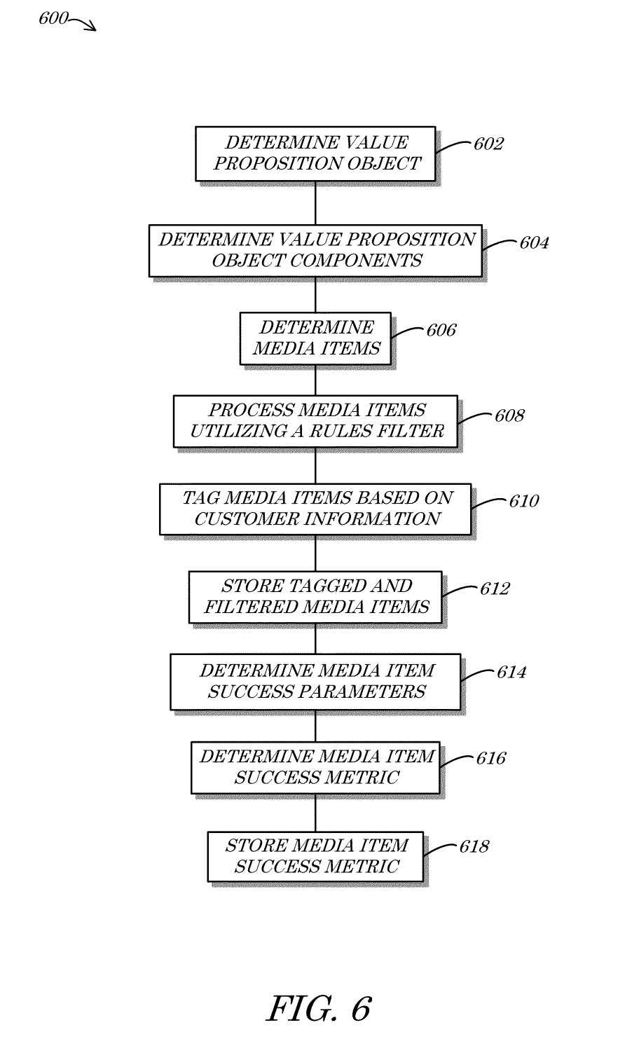

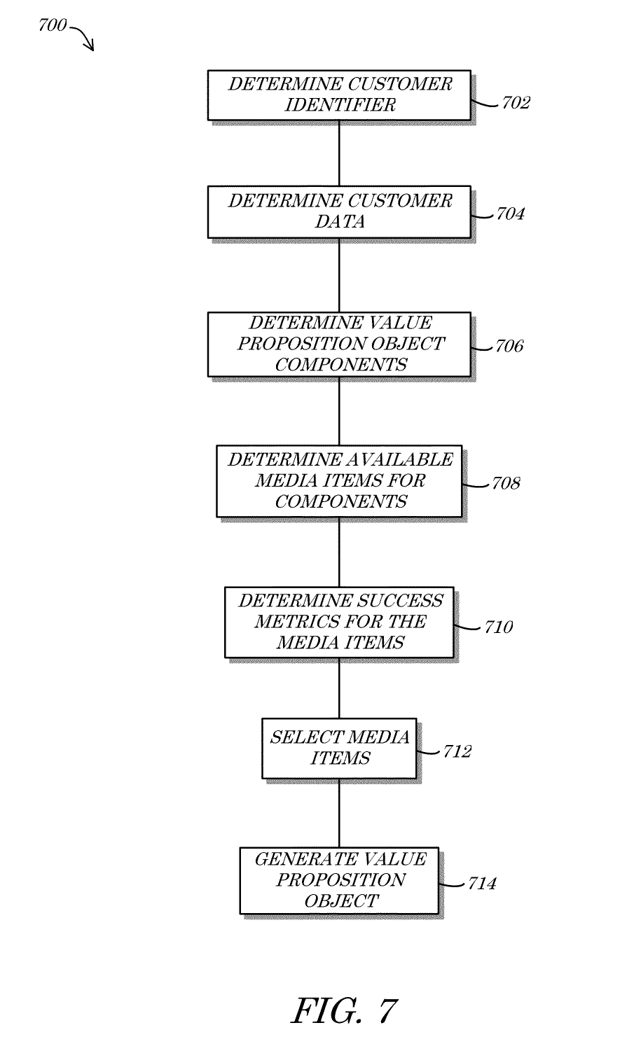

Fewer or more components 102a-n, 104, 106, 110 and/or various configurations of the depicted components 102a-n, 104, 106, 110 may be included in the system 100 without deviating from the scope of embodiments described herein. In some embodiments, the components 102a-n, 104, 106, 110 may be similar in configuration and/or functionality to similarly named and/or numbered components as described herein. In some embodiments, the system 100 (and/or portion thereof) may comprise a value proposition object generation and/or analysis program, application, and/or platform programmed and/or otherwise configured to execute, conduct, and/or facilitate any of the various methods 600, 700 of FIG. 6 and/or FIG. 7 and/or portions or combinations thereof described herein.

The user devices 102a-n, in some embodiments, may comprise any types or configurations of computing, mobile electronic, network, user, and/or communication devices that are or become known or practicable. The user devices 102a-n may, for example, comprise one or more Personal Computer (PC) devices, computer workstations (e.g., underwriter workstations), tablet computers such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, the user devices 102a-n may comprise devices owned and/or operated by one or more users such as underwriters, account managers, agents/brokers, customer service representatives, data acquisition partners and/or consultants or service providers, and/or underwriting product customers. According to some embodiments, the user devices 102a-n may communicate with the controller device 110 via the network 104, such as to conduct provide, analyze, and/or construct value proposition objects as described herein.

In some embodiments, the user devices 102a-n may interface with the controller device 110 to effectuate communications (direct or indirect) with one or more other user devices 102a-n (such communication not explicitly shown in FIG. 1), such as may be operated by other users. In some embodiments, the user devices 102a-n may interface with the controller device 110 to effectuate communications (direct or indirect) with the third-party device 106 (such communication also not explicitly shown in FIG. 1). In some embodiments, the user devices 102a-n and/or the third-party device 106 may comprise one or more sensors and/or data sources configured and/or coupled to sense, measure, calculate, store, and/or otherwise process or determine data descriptive of value proposition objects and/or media items. In some embodiments, such data may be provided to the controller device 110, such that the controller device 110 may provide feedback regarding the data and/or may utilize the data to evaluate value proposition objects and/or media items and/or construct structured value proposition objects.

The network 104 may, according to some embodiments, comprise a Local Area Network (LAN; wireless and/or wired), cellular telephone, Bluetooth®, Near-Field-Communication (NFC), and/or Radio Frequency (RF) network with communication links between the controller device 110, the user devices 102a-n, and/or the third-party device 106. In some embodiments, the network 104 may comprise direct communications links between any or all of the components 102a-n, 106, 110 of the system 100. The user devices 102a-n may, for example, be directly interfaced or connected to one or more of the controller device 110 and/or the third-party device 106 via one or more wires, cables, wireless links, and/or other network components, such network components (e.g., communication links) comprising portions of the network 104. In some embodiments, the network 104 may comprise one or many other links or network components other than those depicted in FIG. 1. The user devices 102a-n may, for example, be connected to the controller device 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-n, 106, 110 of the system 100. The network 104 may comprise one or more cellular telephone networks with communication links between the user devices 102a-n and the controller device 110, for example, and/or may comprise the Internet, with communication links between the controller device 110 and the third-party device 106, for example.

The third-party device 106, in some embodiments, may comprise any type or configuration of computerized processing device, such as a PC, laptop computer, computer server, database system, and/or other electronic device, devices, or any combination thereof. In some embodiments, the third-party device 106 may be owned and/or operated by a third-party (i.e., an entity different from any entity owning and/or operating either the user devices 102a-n or the controller device 110). The third-party device 106 may, for example, be owned and/or operated by a data and/or data service provider such as a text and/or language analysis service, a demographics and/or marketing analysis service, a survey and/or survey results provider, and/or a competitive analysis service provider. In some embodiments, the third-party device 106 may supply and/or provide data, such as value proposition object, media item, sales, customer, survey, competitive analysis, and/or other data to the controller device 110 and/or the user devices 102a-n. In some embodiments, the third-party device 106 may comprise a plurality of devices and/or may be associated with a plurality of third-party entities.

In some embodiments, the controller device 110 may comprise an electronic and/or computerized controller device, such as a computer server communicatively coupled to interface with the user devices 102a-n and/or the third-party device 106 (directly and/or indirectly). The controller device 110 may, for example, comprise one or more PowerEdge™ M910 blade servers manufactured by Dell®, Inc. of Round Rock, Tex. which may include one or more Eight-Core Intel® Xeon® 7500 Series electronic processing devices. According to some embodiments, the controller device 110 may be located remote from one or more of the user devices 102a-n and/or the third-party device 106. The controller device 110 may also or alternatively comprise a plurality of electronic processing devices located at one or more various sites and/or locations.

According to some embodiments, the controller device 110 (and/or one or more of the user devices 102a-n) may store and/or execute specially programmed instructions to operate in accordance with embodiments described herein. The controller device 110 may, for example, execute one or more programs that facilitate the utilization of sales, survey, customer (e.g., sales and/or insurance agent feedback, advice, and/or other data), and/or competitive data to rate and/or analyze value proposition objects and/or media items and/or construct, design, and/or generate structured value proposition objects. According to some embodiments, the controller device 110 may comprise a computerized processing device such as a PC, laptop computer, computer server, and/or other electronic device to manage and/or facilitate transactions and/or communications regarding the user devices 102a-n. A marketing and/or sales professional (and/or customer, client, or company) may, for example, utilize the controller device 110 to (i) acquire and/or analyze data associated with the sale and/or marketing of one or more products such as insurance, indemnity, and/or surety products, (ii) analyze, score, and/or rate one or more value proposition objects and/or media items, (iii) determine which media items to utilize to construct a structured value proposition object, (iv) construct and/or generate a structured value proposition object, and/or (iv) provide an interface via which sales and/or marketing entity (and/or an agent, broker, and/or customer) may manage and/or facilitate production, editing, generation (e.g., via direct selections and/or via feedback-induced automatic selections), and/or utilization of structured value proposition objects (e.g., in accordance with embodiments described herein).

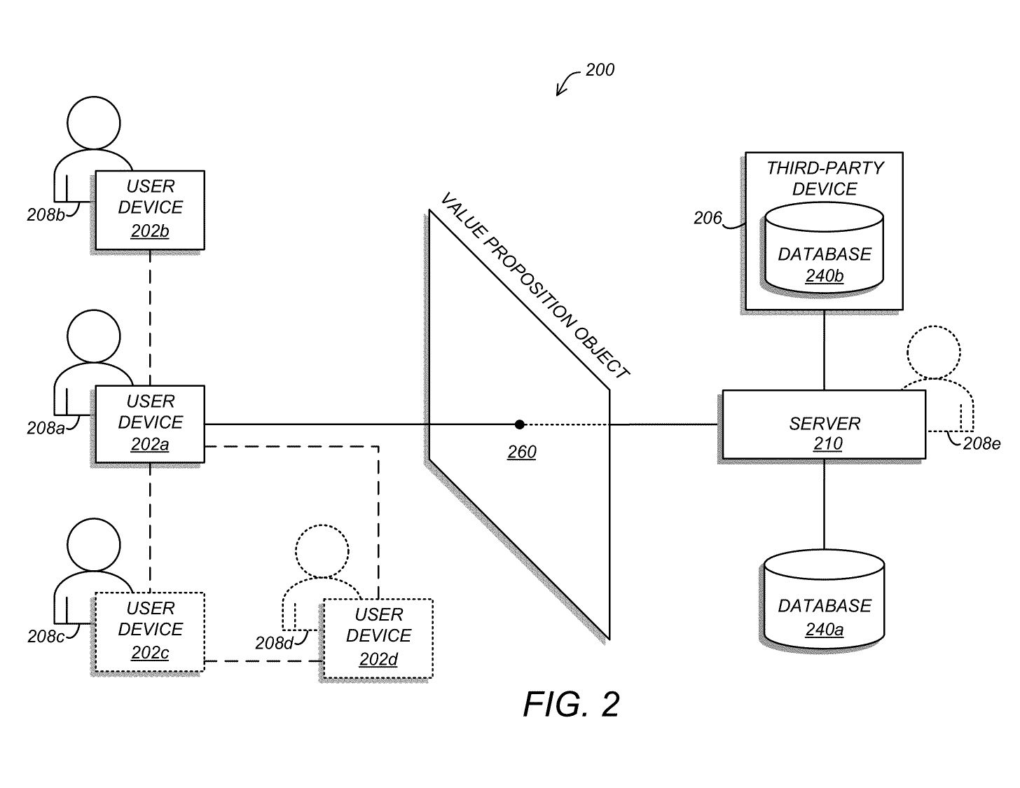

Turning now to FIG. 2, a block diagram of a system 200 according to some embodiments is shown. In some embodiments, the system 200 may comprise one or more user devices 202a-d, a third-party device 206, one or more users 208a-e, a server 210, one or more databases 240a-b, and/or a value proposition object 260. According to some embodiments, any or all of the components 202a-d, 206, 208a-e, 210, 240a-b, 260 of the system 200 may be similar in configuration, quantity, and/or functionality to any similarly named and/or numbered components described herein. Fewer or more components 202a-d, 206, 208a-e, 210, 240a-b, 260 and/or various configurations of the components 202a-d, 206, 208a-e, 210, 240a-b, 260 may be included in the system 200 without deviating from the scope of embodiments described herein. While multiples of some components 202a-d, 208a-e, 240a-b are depicted and while single instances of other components 206, 210, 260 are depicted, for example, any component 202a-d, 206, 208a-e, 210, 240a-b, 260 depicted in the system 200 may be removed from the system 200, may comprise a single device, a combination of devices and/or components 202a-d, 206, 208a-e, 210, 240a-b, 260, and/or a plurality of devices, as is or becomes desirable and/or practicable.

According to some embodiments, the user devices 202a-d may be owned, operated by, and/or otherwise associated with the respective users 208a-d, that may comprise for example, various customers (e.g., current customers and/or potential customers or clients), agents, brokers, sales, and/or marketing staff. A first user 208a may comprise an insurance agent and/or broker, for example, and/or a first user device 202a utilized by the first user 208a may comprise a PC, tablet computer (e.g., iPad®), smart phone, and/or other electronic and/or computing device. In some embodiments, the first user 208a and/or the first user device 202a may transmit the value proposition object 260 (and/or an indication thereof) to the server 210. The server 210 may comprise, for example, an insurance company sales and/or marketing server and/or workstation. In some embodiments, the server 210 may be managed, operated, and/or serviced by a fifth user 208e (e.g., an insurance company staff member, analyst, technician, etc.). In some embodiments, the server 210 (and/or the fifth user 208e) may receive, analyze, deconstruct, filter, tag, score, rank, and/or otherwise process the value proposition object 260. The server 210 may, for example, deconstruct, divide, and/or segment the value proposition object 260 into a plurality of components (not shown in FIG. 2; such as a plurality of media items) and/or store the value proposition object 260 and/or respective components and/or indications thereof in a first database 240a. According to some embodiments, the first user 208a may be representative of a plurality of brokers, agents, and/or other sources of value proposition objects 260 (and/or data descriptive thereof such as object and/or item ratings and/or suggestions), and the server 210 may accordingly receive, process, and/or store a plurality of value proposition objects 260.

In some embodiments, the server 210 may utilize data from the first database 240a and/or data from the third-party device 206 and/or a second database 240b thereof to process the value proposition object 260 and/or components thereof. The server 210 may, as described herein for example, utilize sales, survey, customer, competitive intelligence, demographic, geographic, and/or other data (e.g., any or all of which may be referred to as “success parameters”) associated with a particular value proposition object 260 (and/or component thereof) to score, rank, and/or otherwise develop a “success metric”. The third-party device 206 (and/or second database 240b) may, in some embodiments, provide demographic data descriptive of one or more customers (e.g., personal and/or business insurance customers) associated with the value proposition object 260. The first user 208a (and/or the first user device 202a) may, for example, display and/or provide the value proposition object 260 to a potential customer (e.g., as part of a sales and/or marketing effort), such as a second user 208b and/or respective second user device 202b. In some embodiments, the first user device 202a may provide data descriptive of (e.g., identifying) the second user 208b/potential customer to the server 210. The server 210 may then utilize this received information, for example, to retrieve demographic and/or other data descriptive of the second user 208b from the third-party device 206 (and/or second database 240b thereof).

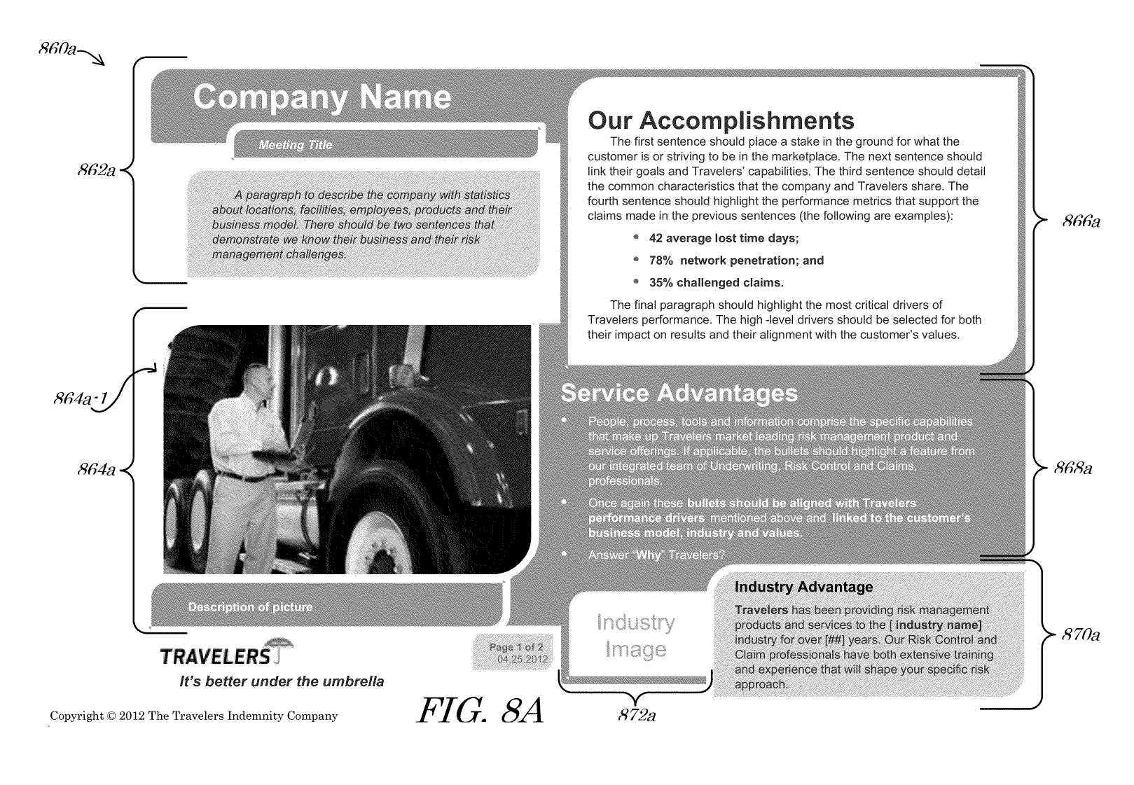

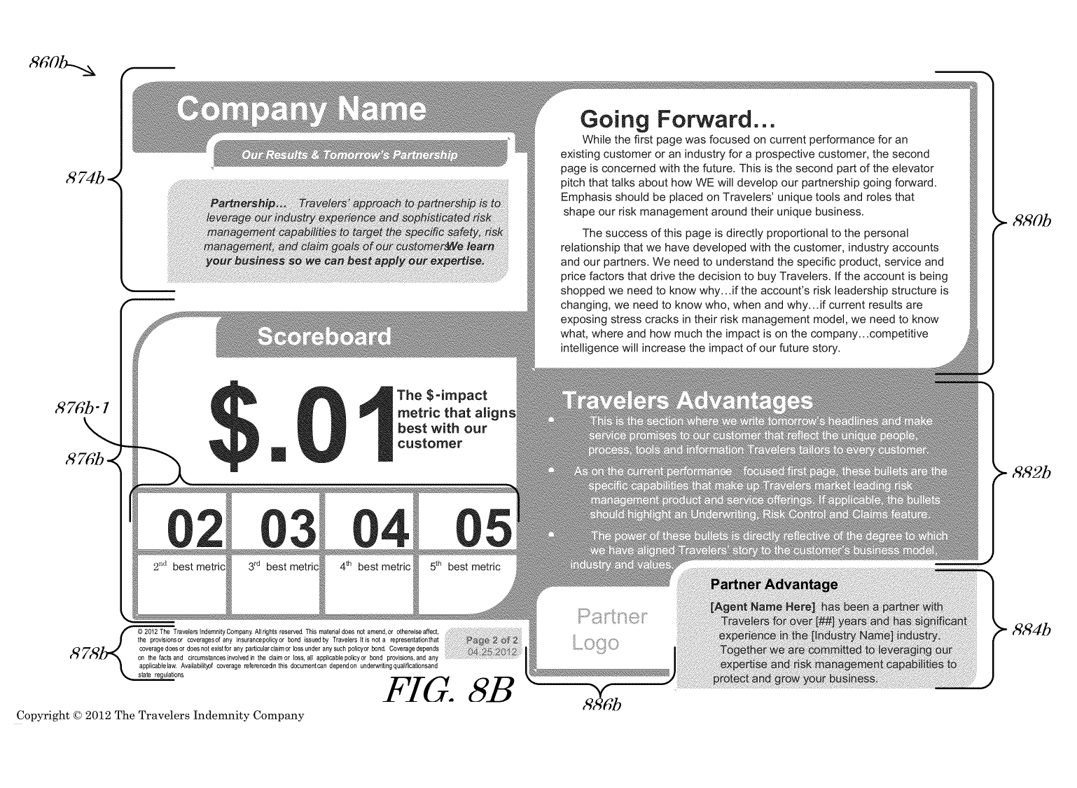

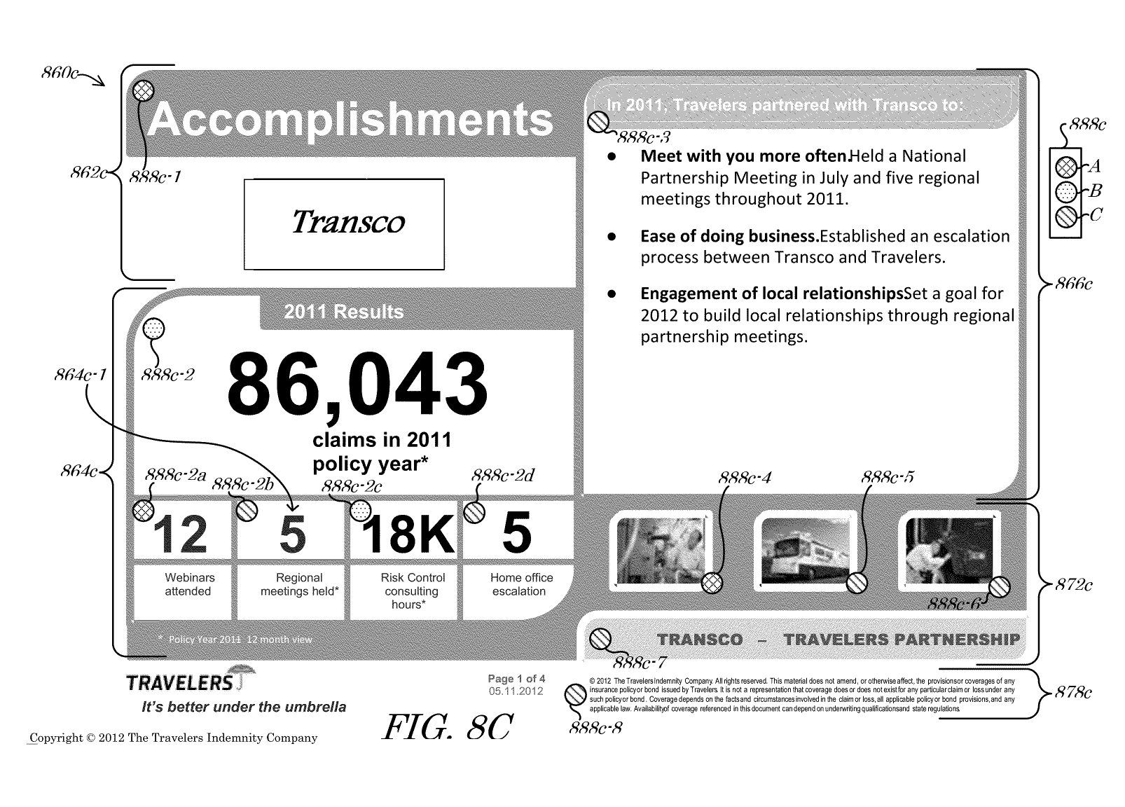

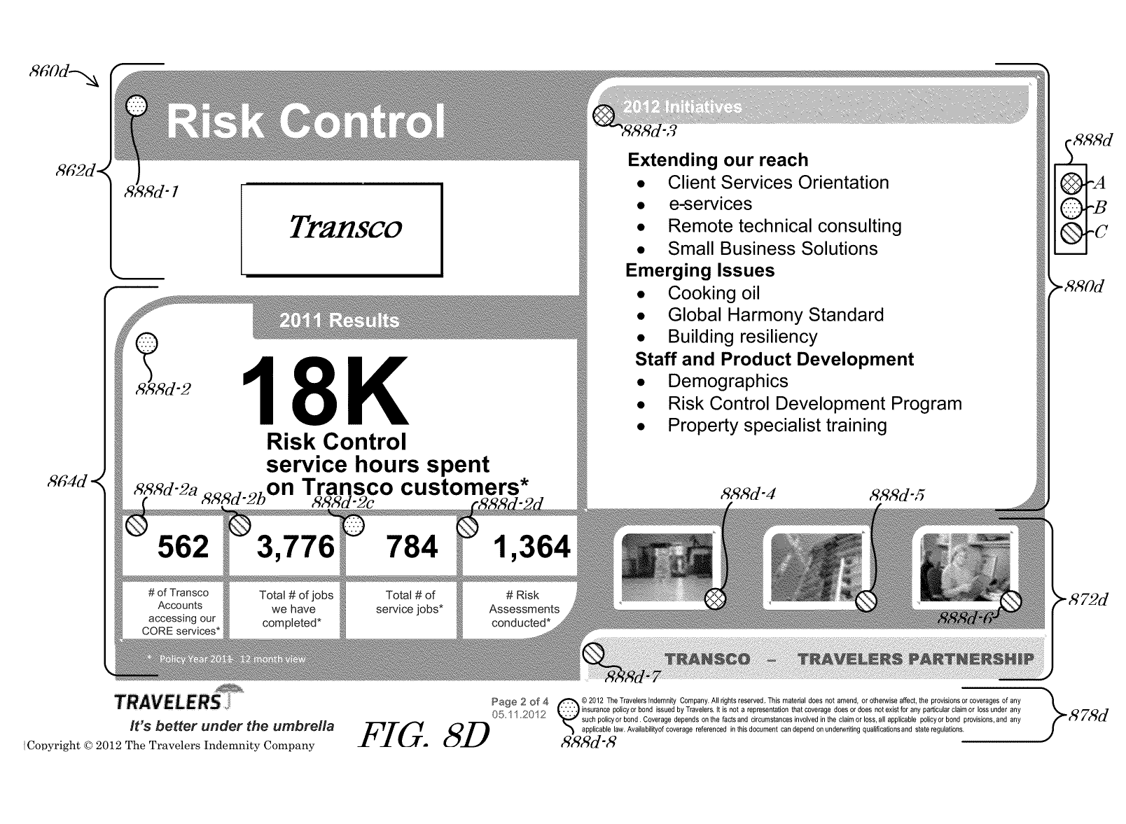

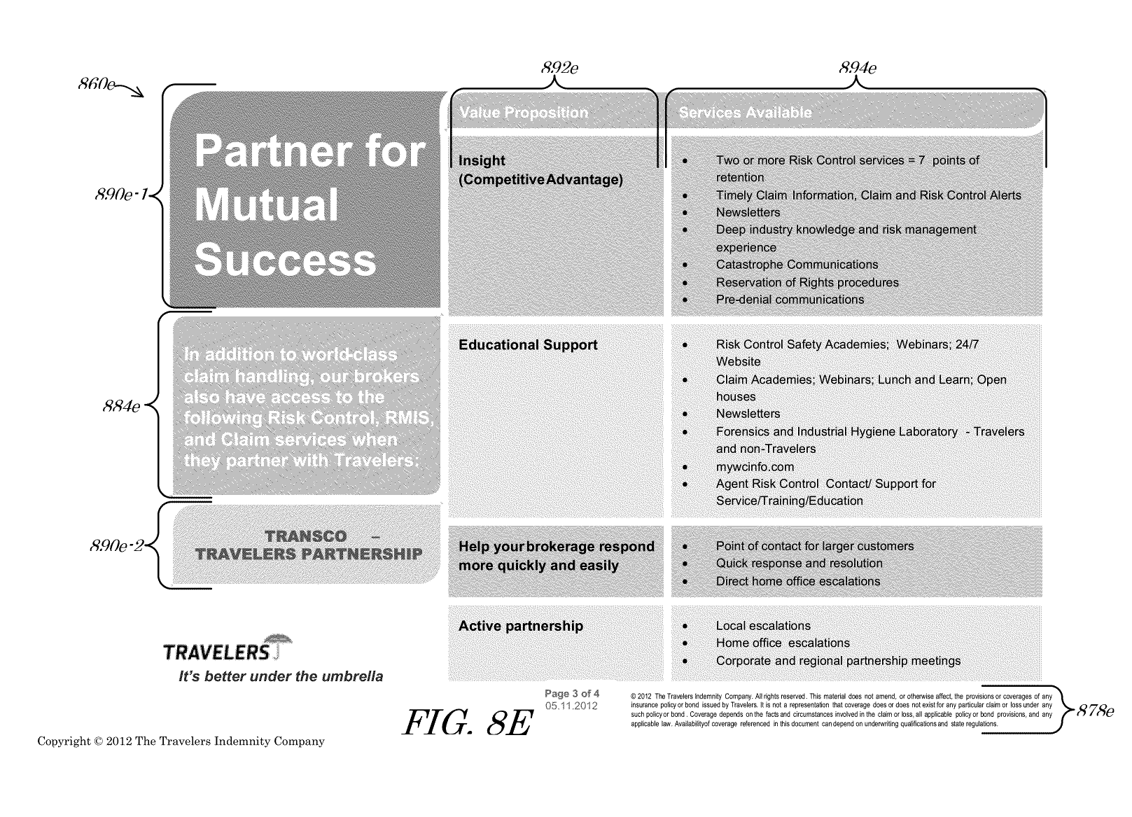

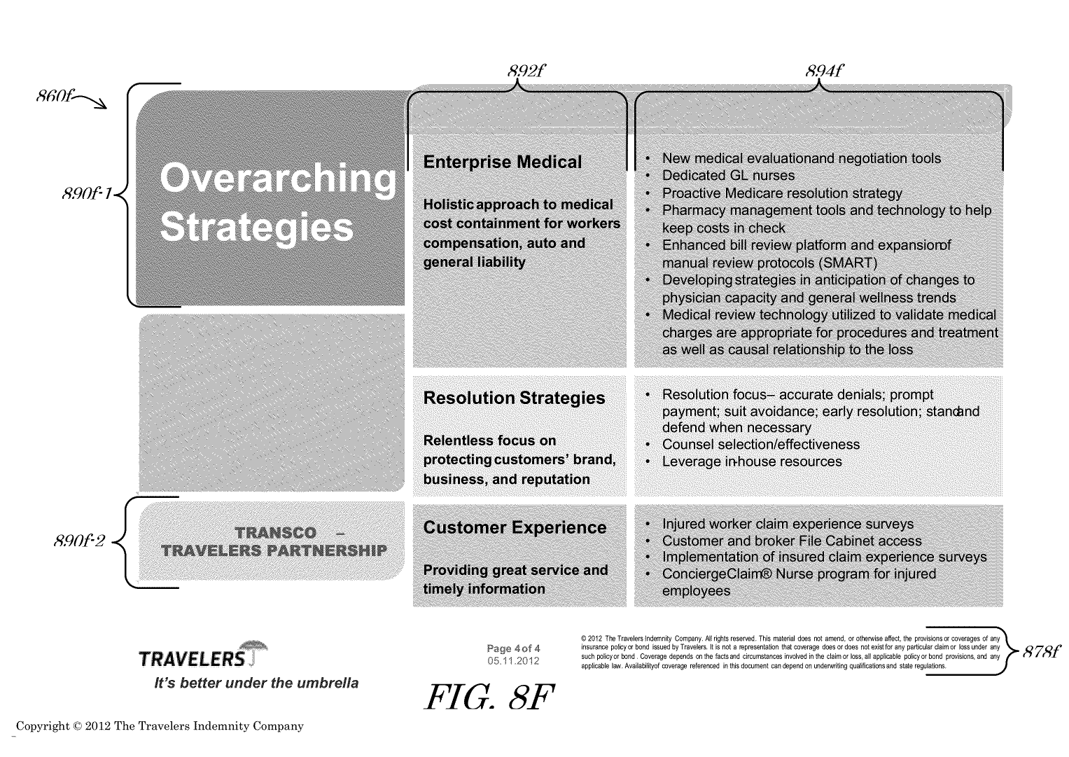

According to some embodiments, the server 210 may also or alternatively retrieve and/or receive sales data indicative of whether or not (and/or to what extent) the sales pitch and/or effort was successful (e.g., a success parameter). Such information may be retrieved from the first database 240a, for example, and/or may be received from the first user device 202a (e.g., via a user interface and/or via a value proposition object such as via the impact palette tools 888c-d of FIG. 8C and/or FIG. 8D herein). In some embodiments, such as in the case that the value proposition object 260 comprises a dashboard and/or interface via which the first user 208a may interact with, select, and/or manipulate value proposition object components, the first user 208a may provide an indication of a success parameter directly to the server 210 via the value proposition object 260 itself. According to some embodiments, the success of the value proposition object 260 may be stored and/or analyzed with respect to the data descriptive of the second user 208b/potential customer. In such a manner, for example, relationships between customer data and value proposition object 260 (and/or component) success may be determined and/or stored. Such relationships may comprise and/or may be utilized to calculated and/or define, for example, one or more success metrics descriptive of the value proposition object 260 and/or components thereof (and/or combinations of components thereof).

In some embodiments, the first user 208a may comprise an insurance agent (e.g., such as in the case that the second user 208b comprises a customer and/or potential customer) and/or broker. In the case that the first user 208a comprises a broker, the first user 208a/broker and/or first user device 202a may be in communication with one or more insurance agents and/or customers such as a third user 208c (and/or respective third user device 202c) and/or a fourth user 208d (and/or respective fourth user device 202d). In some embodiments, the first user 208a/broker may provide the value proposition object 260 (which may comprise a structured value proposition object 260) to either or both of the third user 208c (and/or respective third user device 202c) and/or a fourth user 208d (and/or respective fourth user device 202d). In some embodiments, such as in the case that the third user 208c comprises an agent, the fourth user 202d may comprise a customer and/or potential customer.

According to some embodiments, any or all of the user devices 202a-d and/or respective users 208a-d may interface with the server 210 (directly and/or indirectly, such as via one or more of the other user devices 202a-d) and/or the value proposition object 260. In the case that the value proposition object 260 comprises an interface (e.g., application GUI, kiosk, web-interface, and/or webpage), for example, the user devices 202a-d and/or respective users 208a-d may communicate with the server 210 through and/or via the value proposition object 260. In the case that the value proposition object 260 comprises a hard-copy object (such as a print-out, signage, etc.), the system 200 (and/or server 210 and/or user devices 202a-d) may comprise a printer, plotter, and/or other appropriate output device (not shown in FIG. 2) as is or becomes desirable and/or practicable. In some embodiments, one or more of the users 208a-d may not be associated with a user device 202a-d in the system 200. In the case that the first user 208a comprises a sales agent (and/or first-tier customer/‘internal’ agent, such as a manager in a company) and the third user 208c comprises a potential customer (and/or second-tier customer/‘internal’ customer, such as a senior executive or other decision-maker in the company), for example, the first user 208a may show the value proposition object 260 to the third user 208c via the first user device 202a (e.g., in the case that the value proposition object 260 comprises an electronic object such as an interface and/or file) and/or may provide the value proposition object 260 to the third user 208c (e.g., in the case that the value proposition object 260 comprises a hard-copy object such a printed version of a file, a printed presentation, etc.). In some embodiments, such as in the case that the third user 208c comprises an agent and/or customer, the third user 208c may provide the value proposition object 260 to the fourth user 208d, which may comprise for example, another agent and/or customer.

Although the user devices 202a-d and the server 210 are depicted as separate devices in FIG. 2 in accordance with some embodiments, any or all of the components 202a-d, 206, 210, 240a-b, 260 of the system 200 may be embodied in a single device, apparatus, object, and/or interconnected system. A single entity (such as an insurance company) may own and/or operate devices configured and/or coupled to function as any or all of the components 202a-d, 206, 210, 240a-b, 260 of the system 200, for example, or a single computer and/or computer server or system may perform any or all of the functions of such components 202a-d, 206, 210, 240a-b, 260 as described herein.

In some embodiments, system 200 may facilitate enhanced sales and/or marketing efforts by and/or to the users 208a-d. The potential effectiveness and/or suggested edits (e.g., creating a structured value proposition object 260) to the value proposition object 260 may be obtained, for example, such as in the case that the first user 208a desires to utilize the value proposition object 260 to support sales and/or marketing efforts. According to some embodiments, structured value proposition objects 260 may also or alternatively be suggested and/or provided. Such (structured) value proposition objects 260 may allow a sales and/or marketing entity (e.g., an agent, broker, employee, and/or customer) to increase the likelihood of converting sales prospects into paying customers/clients. The (structured) value proposition objects 260 may, in effect, reverse the typical sales paradigm, leading to increases in revenues, profits, and/or customer acquisition and/or retention.

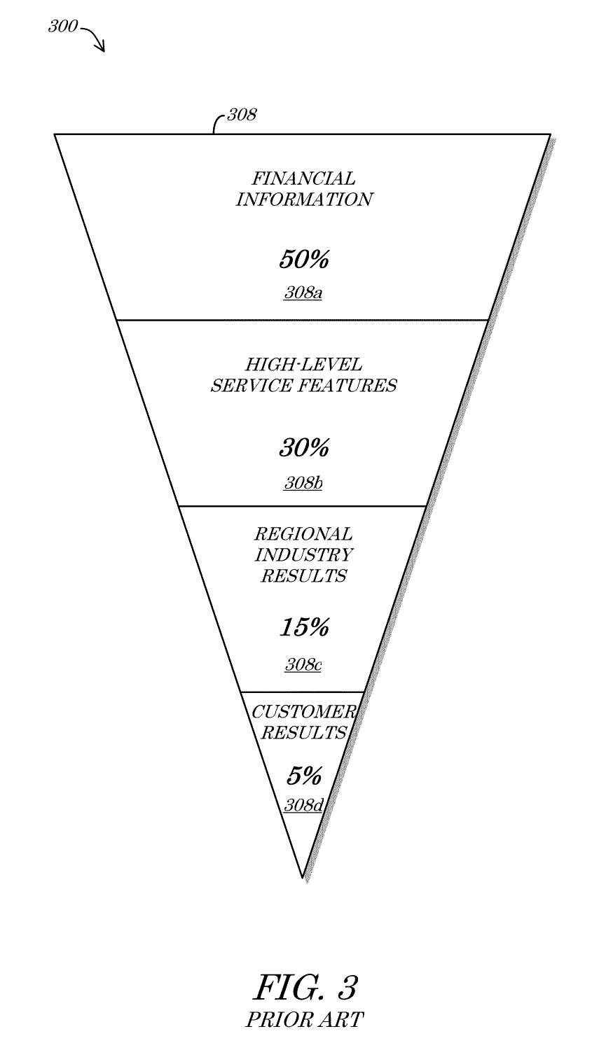

Referring to FIG. 3, for example, a block diagram of a prior art system 300 is shown. In some embodiments, the system 300 may comprise a sales approach graph 308 descriptive of a typical sales paradigm (depicted as an inverse-pyramid graph). The sales approach graph 308 depicts, for example, a sales effort broken down and/or divided into four (4) general sales data categories 308a-d. As depicted, a first sales data category 308a comprises “financial information”. This first sales data category 308a may, for example, comprise information descriptive of a cost and/or price of a particular service and/or product, and/or company financial and/or market information (e.g., indications of a “soundness” of the company whose products and/or services are being marketed/sold, market share, etc.). In the case of an insurance and/or underwriting product, for example, the first sales data category 308a may include information regarding product premiums, coverage limits, deductibles, etc. As shown by the sales approach graph 308, the first sales data category 308a may generally comprise approximately fifty percent (50%) of the information provided in a sales pitch, presentation, and/or effort. In many cases, the percentage is much higher, such as in the case that product and/or service purchases are conducted based on the result of a ‘lowest bidder’ and/or other cost-driven selection methodology.

A second sales category 308b may comprise data descriptive of “high-level service features”. In general, for example, approximately thirty percent (30%) of sales efforts and/or information provided in marketing and/or sales efforts may be directed to providing some level of detail regarding high-level service features. An insurance provider may present a prospective client with information, for example, describing the availability of a mobile device application that allows easier reporting of claims, or detailing the number of claims reporting centers in the country—each directed to general ease of access and/or service availability. Together, the first sales data category 308a and the second sales data category 308b may generally be described as providing “generic” information and may generally comprise approximately eighty percent (80%) of a sales and/or marketing effort.

A third sales category 308c may comprise data descriptive of “regional and/or industry results”. While only generally accounting for approximately fifteen percent (15%) of sales and/or marketing efforts, for example, such data may comprise the largest category 308a-d directed to “specific” or targeted data. Presumably, for example, if the industry and/or region of the potential customer is known, then some general information descriptive of the industry and/or region may be provided in the third sales category 308c.

A fourth sales category 308d may comprise data descriptive of “customer results”. The fourth sales category 308d is generally the most specific, tailored, and/or customized data provided in a sales effort. As such data requires the highest dedication of resources and takes the longest amount of time to prepare, however, it generally only constitutes approximately five (5%) percent of the data provided in a given sales and/or marketing effort. Together, the third sales category 308c and the fourth sales category 308d (or the “specific” data), may only constitute approximately twenty percent (20%) of a sales and/or marketing effort. As described, in some circumstances, such as in the case that a low-bid wins a contract to provide goods and/or services, the small portion of the sales approach graph 308 attributable to “specific” data may constitute any even more minuscule percentage of the sales effort. Such typical sales approaches may be advantageous in some situations (like the low-bid contract), yet may be quite ineffective and/or inefficient in other situations.

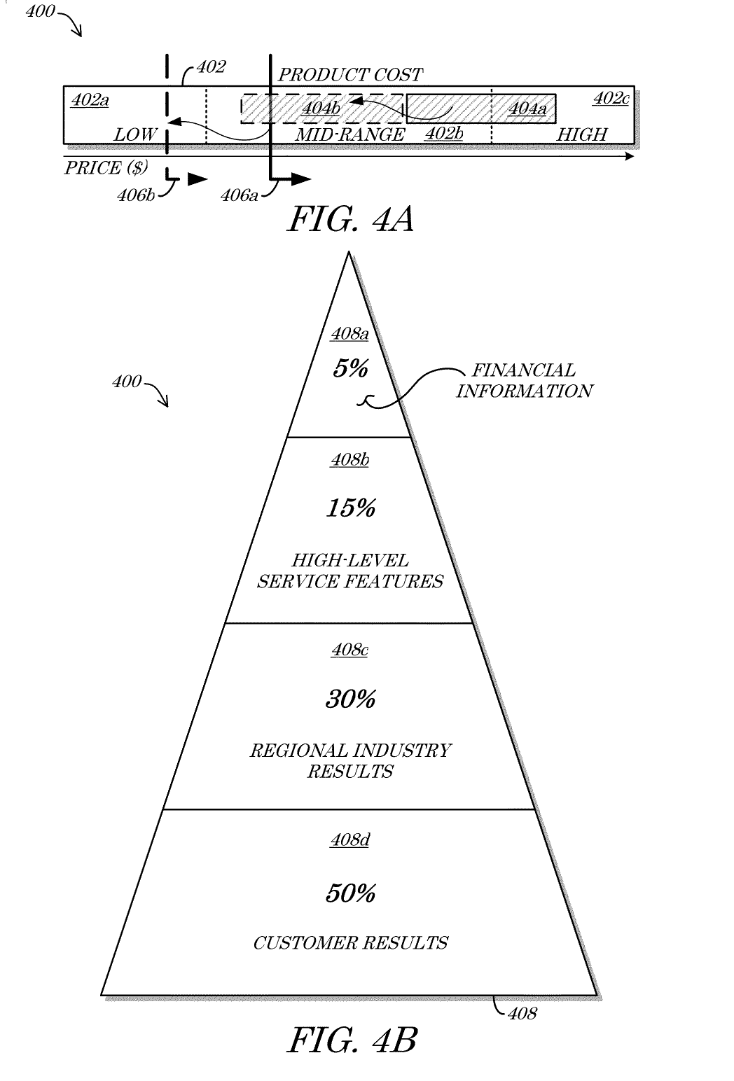

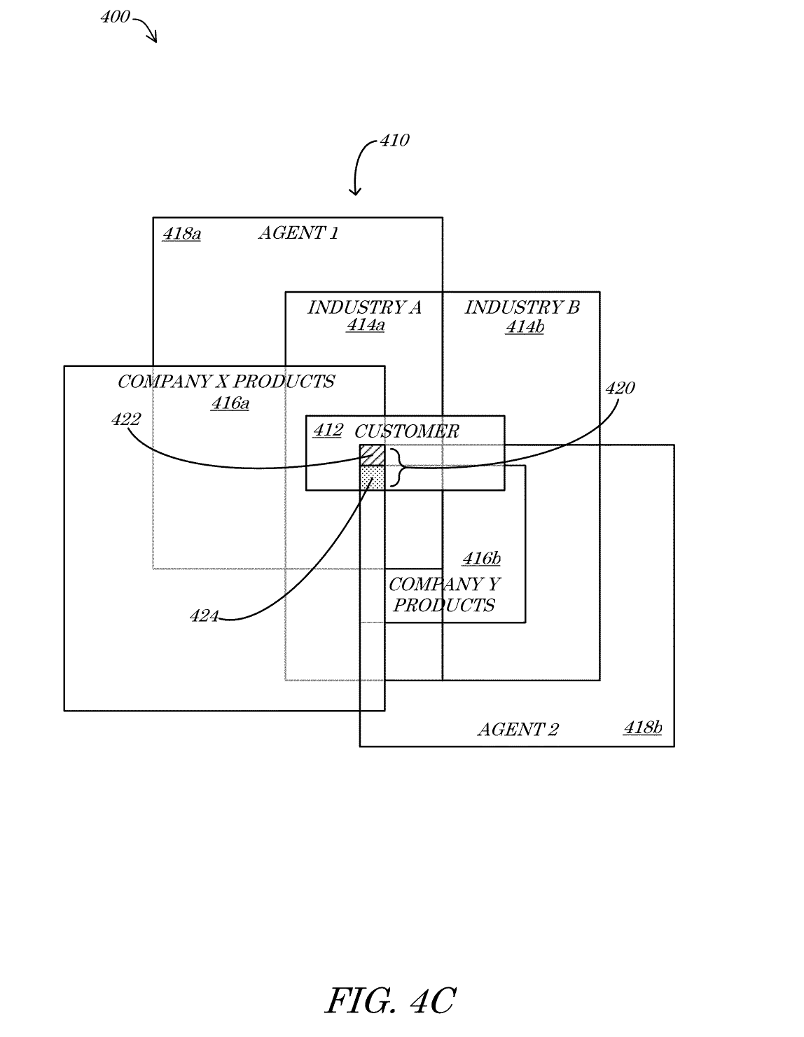

Turning to FIG. 4A, FIG. 4B, and FIG. 4C, for example, block diagrams of a system 400 according to some embodiments are shown. In some embodiments, and referring initially to FIG. 4A, the system 400 may comprise a product and/or service price chart 402. The price chart 402 generally comprises a one-dimensional graph illustrating, for a particular product (and/or, service, and/or combination thereof; e.g., an underwriting product and/or related services), a range of possible product costs (increasing along the horizontal axis from left to right). The price chart 402 may, in some embodiments, be divided (actually or conceptually) into three product cost ranges 402a-c. A “low” product cost range 402a, a “mid-range” product cost range 402b, and/or a “high” product cost range 402c, for example (and as shown).

According to some embodiments, and as described, the prior art sales approach illustrated by the system 300 of FIG. 3 may be effective or even advantageous for a company (and/or other product and/or service provider) marketing and/or selling products/services in the “low” product cost range 402a. Where cost is the predominant factor via which the company competes for business, for example, an allocation of approximately eighty percent (80%) of sales and/or marketing efforts to “generic” data types and/or an allocation of a majority of efforts to financial metrics, may be appropriate and/or may be conducive to achieving desired sales goals.

In the case that a sales and/or marketing effort is set forth for a company offering products/services in the “mid-range” product cost range 402b and/or the “high” product cost range 402c, however, application of the typical sales paradigm may be ineffective at best. For example, in the case that a company markets and/or sells products/services offered for sale in a higher-end cost range 404a and/or above a certain mid-range cost threshold 406a, efforts focused on financial data may prove quite ineffective, as other companies offer an apparently comparable product and/or service at lower (in some cases much lower) cost. It is particularly in these situations (e.g., for products/services offered in the higher-end cost range 404a and/or above the mid-range cost threshold 406a; although certainly not limited to these situations), where altering the typical sales paradigm illustrated in FIG. 3 may be desirable. Altering the typical sales paradigm, for example, may allow a company to shift and/or expand market penetration from higher-end customers in the higher-end cost range 404a (and/or above the mid-range cost threshold 406a) to a broader spectrum of customers in a modified cost range 404b (and/or above a modified cost threshold 406b). The ability to shift the sales and/or marketing focus away from product cost and/or other financial parameters and toward one or more non-price variables and/or parameters may allow a company to compete in market segments that were otherwise not profitable or efficient.

Turning to FIG. 4B, for example, the system 400 may comprise a sales approach graph 408 descriptive of a reversed sales paradigm (depicted as pyramid graph). In the sales approach graph 408, the reverse paradigm is exemplified by the “generic” sales data categories 408a-b constituting approximately twenty percent (20%) of the sales approach, while the “specific” sales data categories 408c-d constitute approximately eighty percent (80%) of the sales approach. In other words, much more emphasis (than is typical) is placed on either or both of a third sales data category 408c descriptive of “regional and/or industry” data and a fourth sales data category 408d descriptive of “customer results”, while much less emphasis (than is typical) is placed on either or both of a first sales data category 408a descriptive of “financial information” and a second sales data category 408b descriptive of “high-level service features”. As described, however, the typical sales paradigm illustrated in system 300 of FIG. 3 exists for several reasons, one of which is that the typical paradigm is generally the easiest, quickest, and least cost-intensive to prepare and deliver. Shifting to the reverse paradigm depicted in FIG. 4B, while desirable, may generally only be possible via implementation of embodiments described herein. One manner of reducing the barriers to implementation of the reverse sales paradigm, in accordance with some embodiments, is the determination of when (and/or where) such a new and improved sales method should be employed.

Turning to FIG. 4C, for example, the system 400 may comprise a box-style set and/or Venn-style diagram 410 displaying logical relationships between various depicted sets 412, 414a-b, 416a-b, 418a-b. The diagram 410 may comprise, in some embodiments, a customer set 412, a first industry (e.g., “industry A”) set 414a, a second industry (e.g., “industry B”) set 414b, a first company's (e.g., “company X”) products set 416a, a second company's (e.g., “company Y”) products set 416b, a first agent (e.g., “agent 1”) set 418a, and/or a second agent (e.g., “agent 2”) set 418b.

The customer set 412 may generally be illustrative of a product and/or service space associated with a customer (not shown in FIG. 4C). The customer set 412 may, for example, represent a customer's product and/or service offerings, activities, and/or assets. As depicted, the customer set 412 spans both industry A and industry B (i.e., the first industry set 414a and the second industry set 414b). The customer may, for example, offer business services in both an appliance delivery service industry and an appliance repair services industry. In some embodiments, as illustrated in FIG. 4C, the first company's products set 416a may include offerings for the first industry 414a but not the second industry 414b, while the second company's products set 416b may include offerings in both industry sets 414a-b. In such embodiments, it may be advantageous for company X to advertise and/or conduct sales to the customer, but only with respect to the customer's activities in industry A.

In particular, a particular product subset 420 of company X's products 416a may be identified as being associated with industry A and the customer. It may also be identified that both “agent 1” and “agent 2” are available to offer products/services corresponding to the product subset 420. In such a manner, for example, the first product subset 420 and/or the appropriate agent to offer products in the first product subset 420 may be identified. In some embodiments, the first product subset 420 may define a group of company X's products 416a for which structured value proposition objects should be created. As depicted in FIG. 4C, such a determination may be made with respect to a specific customer. Similar determinations may also or alternatively be made for other customers, groups of customers, industries, industry groups, etc.

According to some embodiments, it may be determined that a second product subset 422 (illustrated as constituting a portion of the first product subset 420) comprises a group of company X's offerings 416a that are not only targeted to the customer and industry A (e.g., the only industry serviced by company X in the depicted example), but are also unique to company X. In some embodiments, it may be determined that structured value proposition objects may not be required due to a lack of competition. In other words, a determination may be made that a structured value proposition object need not be created with respect to the second product subset 422 (e.g., when advertised and/or offered for sale to the customer from company X). In some embodiments, a third product subset 424 may be identified that comprises a group of company X's offerings 416a that are targeted to the customer and industry A, but in which there is competition with company Y (e.g., overlap between the first company's product set 416a, the second company's product set 416b, and the customer set 412). It may be determined in some embodiments that in the case of the third product subset 424, structured value proposition objects are desirable and/or should be created. Particularly in the case that company X operates in the higher-end cost range 404 and/or above the mid-range cost threshold 406 (both of FIG. 4A) and company Y does not (e.g., company Y can under-price company X), for example, it may be desirable to incorporate structured value proposition objects to gain an advantage over company Y.

In some embodiments, the diagram 410 and/or information associated therewith may also or alternatively be utilized to influence and/or drive the creation and/or editing of a structured value proposition object. The fact that company X has a much larger exposure to industry A than company Y, for example, may comprise a data point and/or element emphasized in a structured value proposition object created for products offered in the third product subset 424, while product offered in the second product subset 422 may be associated with a structured value proposition object that emphasizes company X's relationships with the various agents offering products in the second product subset 422. Other elements of emphasis and/or de-emphasis may be chosen, selected, and/or structured based on which product subset 420, 422, 424 a particular offering is a member of.

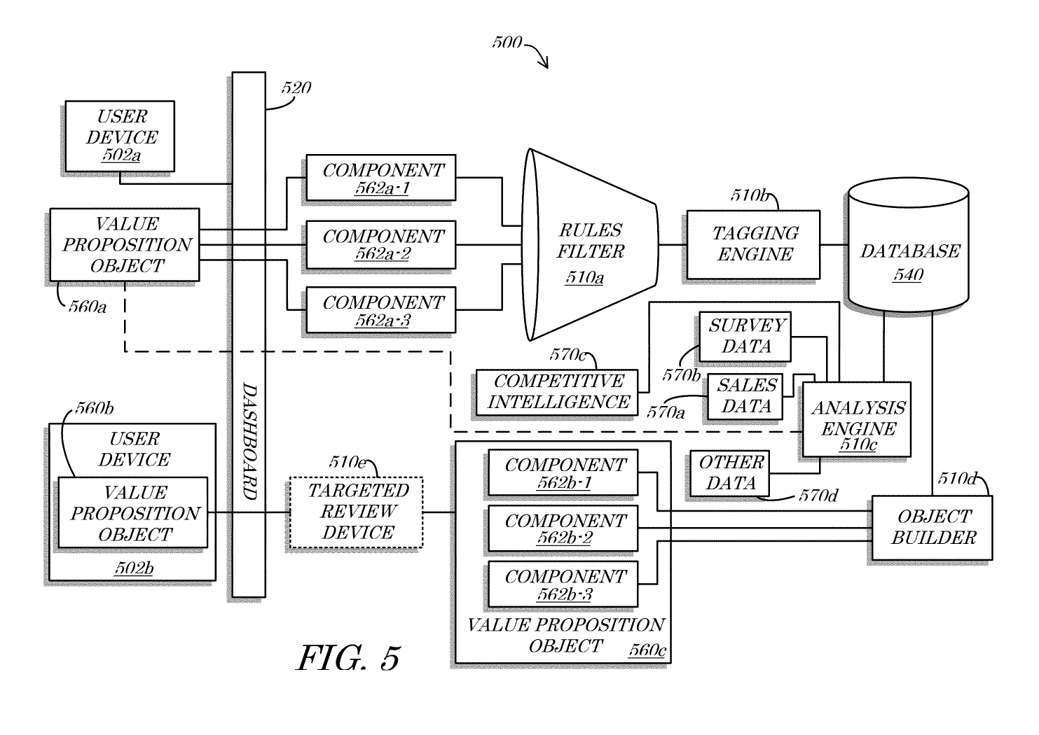

Turning now to FIG. 5, a block diagram of a system 500 according to some embodiments is shown. In some embodiments, the system 500 may comprise one or more user devices 502a-b, a rules filter 510a, a tagging engine 510b, an analysis engine 510c, an object builder 510d, a targeted review device 510e, a dashboard 520, a database 540, a value proposition object 560a (comprising one or more components 562a-1, 562a-2, 562a-3), a structured value composition object 560b and/or a draft structured value proposition object 560c (either or both comprising one or more structured components 562b-1, 562b-2, 562b-3), and/or one or more data sources 570a-d (e.g., sales data 570a, survey data 570b, competitive intelligence 570c, and/or other data 570d). According to some embodiments, any or all of the components 502a-b, 510a-e, 520, 540, 560a-c, 562a-b, 570a-d of the system 500 may be similar in configuration, quantity, and/or functionality to any similarly named and/or numbered components described herein. Fewer or more components 502a-b, 510a-e, 520, 540, 560a-c, 562a-b, 570a-d and/or various configurations of the components 502a-b, 510a-e, 520, 540, 560a-c, 562a-b, 570a-d may be included in the system 500 without deviating from the scope of embodiments described herein. While multiples of some components 502a-b, 510a-e, 560a-c, 562a-b, 570a-d are depicted and while single instances of other components 520, 540 are depicted, for example, any component 502a-b, 510a-e, 520, 540, 560a-c, 562a-b, 570a-d depicted in the system 500 may be removed from the system 500, may comprise a single device, a combination of devices and/or components 502a-b, 510a-e, 520, 540, 560a-c, 562a-b, 570a-d, and/or a plurality of devices, as is or becomes desirable and/or practicable.

In some embodiments, the system 500 may be utilized to (i) acquire and/or gather value proposition object and/or media item data, (ii) process and/or analyze value proposition and/or media object data, (iii) rate and/or provide feedback and/or suggestions regarding value proposition object data, (iv) acquire and/or gather success parameter data, (v) analyze and/or process success parameter data, and/or (vi) create, generate, and/or disseminate structured value proposition object data.

A first user device 502a may, for example, utilize the dashboard 520 to input, define, and/or provide information descriptive of a value proposition object 560a. In the case that the value proposition object 560a comprises a hard-copy object, the first user device 502a (and/or a peripheral device thereof not shown separately in FIG. 5) may, for example, scan, photograph, and/or perform Optical Character Recognition (OCR) on the value proposition object 560a. In the case that the value proposition object 560a comprises an electronic file and/or object, the value proposition object 560a may be e-mailed, texted, and/or otherwise electronically forwarded to and/or via the dashboard 520. In some embodiments, the system 500 and/or the dashboard 520 may determine that the value proposition object 560a comprises a plurality of components 562a-1, 562a-2, 562a-3. In some embodiments, the components 562a-1, 562a-2, 562a-3 may be identified by the first user device 502a. According to some embodiments, the components 562a-1, 562a-2, 562a-3 may be identified by the dashboard 520 (and/or software and/or application instructions thereof) and/or the system 500. The system 500 and/or the dashboard 520 may, for example, parse, divide, separate, and/or otherwise virtually and/or structurally split the value proposition object 560a into the plurality of components 562a-1, 562a-2, 562a-3.

In some embodiments, the plurality of components 562a-1, 562a-2, 562a-3 may, as described herein, comprise any quantity and/or configuration of media items, such as (but not limited to) paragraphs, phrases, words, pictures, photographs, images, graphics, video, audio, and/or any combinations thereof. A first component 562a-1 may comprise an industry photograph, for example, while a second component 562a-2 may comprise a particular tagline, trademark, trade dress, slogan, and/or phrase.

According to some embodiments, the plurality of components 562a-1, 562a-2, 562a-3 may be fed into, provided to, and/or otherwise received by the rules filter 510a. The rules filter 510a may, in some embodiments, be utilized to identify and/or remove any portions of the plurality of components 562a-1, 562a-2, 562a-3 that are undesirable for various reasons, such as public relations and/or legal issues. Various stored rules, criteria, and/or instructions may be programmed into and/or executed by the rules filter 510a, for example, producing redacted, filtered, and/or edited versions of the plurality of components 562a-1, 562a-2, 562a-3.

In some embodiments, the plurality of components 562a-1, 562a-2, 562a-3 may be processed by the tagging engine 510b. The tagging engine 510b may, for example, tag the plurality of components 562a-1, 562a-2, 562a-3 and/or portions thereof based on information known and/or determined regarding the plurality of components 562a-1, 562a-2, 562a-3. While not explicitly shown in FIG. 5, for example, the first user device 502a and/or the value proposition object 560a may comprise and/or provide information descriptive of the value proposition object 560a, the actual and/or intended usage of the value proposition object 560a, and/or other sales and/or marketing environment data descriptive of the value proposition object 560a (and/or of one or more of the plurality of components 562a-1, 562a-2, 562a-3 thereof). In some embodiments for example, a customer identifier, agent identifier, broker identifier, industry identifier, time code, sales success indicator, and/or other relevant information may be acquired by the system 500 and/or utilized by the tagging engine 510b. According to some embodiments, the tagging engine 510b may associate (e.g., tag) different ones of the plurality of components 562a-1, 562a-2, 562a-3 with different information. It may be determined, for example, that a third component 562a-3, comprising a video of a claims adjuster inspecting a commercial vehicle, should be tagged with a “business insurance” and/or “long-haul trucking” tag. In the case that it is known and/or determined that the value proposition object 560a (comprising the third component 562a-3) resulted in and/or was involved in a successful sales pitch to a customer in the long-haul trucking industry, the value proposition object 560a and/or the third component 562a-3 may be tagged both with an indication of the industry (and/or the customer) and an indication of a successful sale. In some embodiments, tags may comprise flags and/or prompts descriptive of time-variable and/or sensitive media item data. A tag may comprise, for example, a prompt to check and/or validate changing state regulations and/or other time-variable concerns associated with a media object (and/or component 562a-1, 562a-2, 562a-3).

According to some embodiments, the plurality of components 562a-1, 562a-2, 562a-3 (e.g., as filtered, edited, and/or tagged) may be stored in the database 540. In some embodiments, such as in the case the value proposition object 560a comprises a plurality of objects, input, processing, and/or storage of the value proposition object 560a and/or the plurality of components 562a-1, 562a-2, 562a-3 thereof may comprise an aggregation of sales, marketing, and/or related data in the database 540.

In some embodiments, the analysis engine 510c may utilize the data stored in the database 540 to analyze and/or process the value proposition object 560a and/or the plurality of components 562a-1, 562a-2, 562a-3 thereof (and/or a plurality of other objects, components, and/or items). In some embodiments, the analysis engine 510c may acquire and/or receive (or otherwise determine) one or more of the sales data 570a, survey data 570b, and/or competitive intelligence 570c. The analysis engine 510c may utilize any such data 570a-c to process the value proposition object 560a and/or the plurality of components 562a-1, 562a-2, 562a-3, for example, and/or may store any such data 570a-c in the database 540 (e.g., in relation to the value proposition object 560a and/or the plurality of components 562a-1, 562a-2, 562a-3 and/or for future processing and/or reference).

According to some embodiments, such as in the case that the value proposition object 560a and/or the plurality of components 562a-1, 562a-2, 562a-3 are at least tagged and stored in association with customer, industry, and/or other sales/marketing environment data, the analysis engine 510c may compare such data to any or all of the sales data 570a, survey data 570b, and/or competitive intelligence 570c to determine one or more success parameters and/or metrics for the value proposition object 560a and/or the plurality of components 562a-1, 562a-2, 562a-3. In the case that the second component 562a-2 comprises a certain phrase utilized in marketing for a variety of industries, for example, any or all of the sales data 570a, survey data 570b, and/or competitive intelligence 570c may be utilized to determine how successful the utilization of the second component 562a-2 has been. Sales data 570a may show, for example, that the second component 562a-2 has been utilized forty (40) times in sales pitches, and only four (4) of those pitches have resulted in sales (and/or sales of a certain magnitude and/or type). In other words, the second component 562a-2 may only have been successful ten percent (10%) of the time. When explored further (e.g., by the analysis engine 510c) however, it may be determined that all four (4) of the successful pitches were in the same industry, sub-industry, region, locality, etc. It may accordingly be determined, for example, that the second component 562a-2 is highly successful when utilized in certain industry and/or geographic sales and/or marketing segments.

In some embodiments, the analysis engine 510c may calculate and/or compute such probabilities and/or parameters and/or may derive, define, and/or calculate or otherwise determine one or more success metrics. A success metric may, for example, comprise a rank (e.g., relative to other phrases and/or similar media items), score (e.g., based on the historical success rate, number of tags associated therewith, etc.), and/or other indicator of success and/or likelihood of success. According to some embodiments, a success metric may be weighted and/or flagged based on one or more success parameters upon which it is defined. Most indications for a particular sales effort may indicate a likelihood of success, or even positive feedback from potential customers, for example, but ultimately the sale may not be successful for some external and/or outlying reason unrelated to the attributes of the value proposition object and/or any of the components (e.g., unfavorable market events, such as a product recall, and/or a poor delivery of a pitch by the sales representative). In such embodiments, a success metric may be maintained as a positive indicator, effectively ignoring the unsuccessful result as being an outlier, and/or may be otherwise skewed, weighted, and/or altered to reflect the likelihood that the media items are likely to be successful in future efforts.

In some embodiments, the survey data 570b may comprise data from customer, industry, and/or focus group surveys (physical and/or virtual) descriptive of an affinity for a particular media item. In the case of the example where the second component 562a-2 comprises a certain phrase, for example, survey data 570b may indicate that potential customers do not favor (and/or do not react favorably to) the phrase. Such data may be reflected in the success metric, such as for example, reducing the score of the second component 562a-2. In some embodiments, the competitive intelligence 570c may comprise data regarding what other companies competing for sales in the same markets/industries have utilized in marketing and/or sales efforts and/or which of those items have been successful (or not). In some embodiments, competitive intelligence 570c may comprise feedback from a potential customer that, for example, did not consummate a sale where the second component 562a-2 was utilized, but instead chose a different company that utilized one or more different media items. The potential customer/lost sale prospect may, for example, specifically identify a media item and/or object utilized by the competing company that ‘made’ the sale and/or identify the second component 562a-2 as a media item that caused the customer to go with the other company. Such competitive intelligence 570c may be reflected in the success metric, such as for example, reducing the score of the second component 562a-2 and/or increasing the score of a media item similar and/or identical to the successful object utilized by the other company. In some embodiments, the other data 570d may comprise any other type, quantity, and/or configuration of data that is or becomes desirable and/or practicable. The other data 570d may comprise, for example, data descriptive of one or more externalities, such as weather, web browsing cookies (and/or other audit and/or tracking data), business data, etc.

According to some embodiments, the analysis engine 510c may provide feedback and/or suggestions regarding the value proposition object 560a. The analysis engine 510c may, for example, communicate analysis results such as success metrics (e.g., scores, weights, rankings) and/or suggestions (e.g., “don't utilize the first component 562a-1”) to the first user device 502a. In some embodiments, such as in the case that the value proposition object 560a comprises an electronic object, the analysis engine 510c may provide and/or suggest edits (e.g., via the dashboard 520). In the case that the value proposition object 560a comprises a hard-copy object, the analysis engine 510c may comprise and/or cause a printer and/or other hard-copy output device (not explicitly shown in FIG. 5) to edit and/or revise or markup the value proposition object 560a. According to some embodiments, feedback and/or edits from the analysis engine 510c may cause the value proposition object 560a to become “structured”—i.e., targeted/customized based on success metrics associated with one or more of the individual components 562a-1, 562a-2, 562a-3.

In some embodiments, a second user device 502b may interface with the dashboard 520 and/or the system 500. The second user interface 502b may, for example, be utilized to retrieve, request, generate, construct, and/or otherwise define and/or determine the structured value proposition object 560b. The second user device 502b and/or the dashboard 520 may be utilized, for example, to provide sales and/or marketing data to the object builder 510d. The object builder 510d may receive (e.g., via the dashboard 520 and/or from the second user device 502b), in some embodiments, an indication of customer data such as a customer identifier, customer industry, customer geography, customer demographics, etc. In some embodiments, the customer identifier may be utilized to retrieve other customer-related data, such as from the database 540. In some embodiments, the first user device 502a and the second user device 502b may comprise the same device (e.g., utilized at different times, by different users, and/or for different purposes).

According to some embodiments, the object builder 510d may utilize the customer information and stored results from the analysis engine 510c (and/or stored media item data) to determine various factors that define the structured value proposition object 560b. The object builder 510d may determine, for example, how many and/or which structured components 562b-1, 562b-2, 562b-3 should be included in the structured value proposition object 560b, how many and/or which media items should be included in the structured components 562b-1, 562b-2, 562b-3, and/or how such structured components 562b-1, 562b-2, 562b-3 and/or media items should be arranged, grouped, presented (e.g., font size, color, and/or line weights), etc. The object builder 510d may, in some embodiments, select and/or define the structured components 562b-1, 562b-2, 562b-3 that define a draft structured value proposition object 560c by selecting the structured components 562b-1, 562b-2, 562b-3 from a larger set of available media items stored in the database 540, such as based on success metrics developed by the analysis engine 510c. In such a manner, for example, the draft structured value proposition object 560c may be targeted, customized, and/or optimized for a particular client, customer, agent, broker, industry, geography, etc.

According to some embodiments, the object builder 510d may implement (e.g., in association with the analysis engine 510c) an adaptive modeling process such as a champion/challenger approach to generating and/or defining the structured components 562b-1, 562b-2, 562b-3 (and/or the structured value proposition object 560b). The object builder 510d may randomly and/or otherwise select a lower-ranked and/or un-ranked media item and/or structured component 562b-1, 562b-2, 562b-3 from an available set, for example, and future feedback (e.g., received via a user interface and/or via a value proposition object, such as via the impact palette tools 888c-d of FIG. 8C and/or FIG. 8D herein) regarding the success of the media items and/or structured component 562b-1, 562b-2, 562b-3 may be processed by the analysis engine 510c to update scoring and/or selection algorithms.

In some embodiments, the draft structured value proposition object 560c may be provided to and/or output by the second customer device 502b (e.g., via the dashboard 520) as the structured value proposition object 560b. In some embodiments, the dashboard 520 may comprise the draft structured value proposition object 560c and/or the structured value proposition object 560b. In some embodiments, the draft structured value proposition object 560c may be provided to the targeted review device 510e (e.g., prior to being provided as the structured value proposition object 560b). The targeted review device 510e may, for example, comprise a computing device utilized by marketing, public relations, legal, and/or other review personnel and/or teams (not shown in FIG. 5). In some embodiments, one or more of the structured components 562b-1, 562b-2, 562b-3 of the draft structured value proposition object 560c may be pre-flagged for review and/or pre-flagged as not requiring review. In the case that the second structured component 562b-2 comprises a legal disclaimer already reviewed and/or filtered by the rules engine 510a, for example, the second structured component 562b-2 may be provided to the targeted review device 510e with an indication that the language thereof has already been reviewed, filtered, edited, and/or approved. The second structured component 562b-2 may be highlighted (or grayed-out), for example, allowing any review and/or analysis by the targeted review device 510e to be focused only on the portions of the draft structured value proposition object 560c that have not yet, and/or otherwise need to be, reviewed. The targeted review device 510e may then, in some embodiments, provide the structured value proposition object 560b to and/or via the dashboard 520 and/or the second customer device 502b.

Turning now to FIG. 6, a flow diagram of a method 600 according to some embodiments is shown. In some embodiments, the method 600 may comprise a value proposition object and/or media item analysis and/or scoring method which may, for example, be described as a “scoring engine”. According to some embodiments, the method 600 may be implemented, facilitated, and/or performed by or otherwise associated with any of the systems 100, 200, 500 of FIG. 1, FIG. 2, and/or FIG. 5 herein. In some embodiments, the method 600 may be associated with the method 700 of FIG. 7. The method 600 may, for example, comprise a portion of the method 700 and/or may comprise a precursor to and/or prerequisite for the method 700. In some embodiments, the method 600 may be performed and/or implemented by and/or otherwise associated with one or more specialized and/or specially-programmed computers (e.g., the user devices 102a-n, 202a-d, 502a-b the third-party devices 106, 206, and/or the controller devices 110, server 210, and/or processing components 510a-e, of FIG. 1, FIG. 2, and/or FIG. 5), computer terminals, computer servers, computer systems and/or networks, and/or any combinations thereof (e.g., by one or more insurance company and/or underwriter computers).

The process diagrams and flow diagrams described herein do not necessarily imply a fixed order to any depicted actions, steps, and/or procedures, and embodiments may generally be performed in any order that is practicable unless otherwise and specifically noted. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the data storage devices 340, 840, 1240a-d of FIG. 3, FIG. 8, FIG. 12A, FIG. 12B, FIG. 12C, and/or FIG. 12D herein) may store thereon instructions that when executed by a machine (such as a computerized processor) result in performance according to any one or more of the embodiments described herein

According to some embodiments, the method 600 may comprise determining a value proposition object, at 602. Any number and/or configuration of hard-copy and/or electronic value proposition objects such as sales and/or marketing presentations, videos, demonstrations, sales pitch materials, talking points, advertisements, etc., may be acquired, received, looked-up, scanned, input, and/or otherwise determined. According to some embodiments, historic, legacy, and/or archived sales and/or marketing materials may be acquired and/or identified. According to some embodiments, a policy may be implemented (procedurally and/or logistically, such as by requiring utilization of a certain software and/or hardware tool and/or application) requiring all new sales/marketing materials to be submitted prior to being utilized. According to some embodiments, information identifying a customer (e.g., potential or existing), a customer identifier, customer data, and/or industry, geography, and/or demographic data may be determined and/or received (e.g., in association with and/or with or as part of one or more of the value proposition objects).

In some embodiments, the method 600 may comprise determining value proposition object components, at 604. Information may be received, for example, identifying a plurality of components and/or the value proposition object may be parsed, split, divided, partitioned, and/or otherwise segmented into such components. In some embodiments, a template or mask may be applied to segment the value proposition object into various components. In some embodiments, the components may be identified and/or segmented based on physical and/or virtual location (e.g., in or on the value proposition object). Each quadrant may be identified as a component, for example, and/or a grid system may be employed to identify one or more components. In some embodiments, the components may be identified and/or suggested by the user. In some embodiments, one or more rules may be executed to determine the components that constitute the value proposition object.

According to some embodiments, the method 600 may comprise determining one or more media items, at 606. In some embodiments, such as in the case that each identified and/or determined component comprises a different media item (and/or media item type), the identifying of the components may be equivalent to an identifying of the one or more media items. According to some embodiments, each component may comprise a plurality of media items. In some embodiments, each component may represent (and/or be identified based on) a different purpose and/or function. One component may be configured to provide information descriptive of financial metrics, for example, while another component may be configured to provide information descriptive of customer-specific results. Each such component may comprise a plurality of media items configured (and/or selected) to provide the type of information specific to the component to which it belongs. A first portion of the value proposition object may comprise an industry results component, for example, that comprises both a photograph representative of a specific industry and a textual description of results achieved in the industry (e.g., by a particular company, such as an insurance company, a particular product and/or a particular service). Each of the photograph and the textual description may be identified as distinct media items. According to some embodiments, the textual description itself may comprise one or more media items. The textual description may be determined, for example, to include a plurality of sentences, phrases, grammatical structures, punctuation, and/or words—each of which may be identified as a media item.

In some embodiments, the method 600 may comprise processing the media items utilizing a rules filter, at 608. The media items may be analyzed by execution and/or application of a plurality of stored rules, for example, such as public relations rules (e.g., configured to filter out potentially offensive words, phrases, and/or pictures), legal rules (e.g., ensuring that the media items comply with applicable regulations and/or guidelines or best practices), and/or sales or marketing rules (e.g., configured to ensure certain photos, words, phrases, etc., either are or are not utilized). In some embodiments, the filter rules may alter the media items to comply with desired formatting, content, etc. In some embodiments, the filter may not alter the media items, but may flag and/or tag the media items and/or portions thereof with rules-based information. A media item that may not be appropriate and/or legal in a particular jurisdiction, for example, may be flagged, tagged, and/or noted as such (e.g., so that the media item will not be utilized in such jurisdiction in the future).

According to some embodiments, the method 600 may comprise tagging the media items based on customer information, at 610. The value proposition object may include and/or be provided with, for example, information descriptive of how, when, and/or where the value proposition object is, was, and/or is going to be utilized (e.g., in a sales and/or marketing presentation). Such information may, in some embodiments, comprise information identifying one or more customers (e.g., customers that have seen and/or are planned to view the value proposition object). In some embodiments, the customer information may comprise (but is not limited to) information identifying the customer (i.e., customer, potential customer, former customer, agent, broker, etc.), information descriptive of an industry of the customer, information descriptive of a business of the customer, externality data, time-sensitive and/or dynamic data, and/or information descriptive of a geography of the customer. The media items, components, and/or the value proposition object may be tagged with information relating the customer information to the media items, components, and/or the value proposition object. Tagging may comprise populating fields in a meta-tag file, for example, and/or may comprise linking the customer data to the media item (and/or component and/or value proposition object) data in one or more databases, data tables, etc.

In some embodiments, the method 600 may comprise storing the filtered and tagged media items, at 612. Once the media items, components, and/or value proposition object are filtered and/or tagged, for example, the media items themselves (and/or indications thereof) may be stored. The media files may be scanned into electronic format (e.g., if originally in hard-copy format) and/or may be saved to one or more specific locations. In some embodiments, the storing may comprise storing, defining, and/or creating one or more database tables, links, and/or keys—e.g., one or more primary and/or secondary keys linking a stored media item (and/or portion thereof) to other data such as industry, business, geography, demographic, customer, and/or sales data.

According to some embodiments, the method 600 may comprise determining media item success parameters, at 614. In some embodiments, one or more success parameters may have already been associated with and/or related to the value proposition object, components, and/or media items, such as during the processing and/or filtering at 608, the tagging at 610, and/or the storing at 612. In the case that the value proposition object is provided along with an indication of whether the value proposition object was utilized successfully in a sales and/or marketing effort (e.g., via an indication input into a user interface and/or via a value proposition object, such as via the impact palette tools 888c-d of FIG. 8C and/or FIG. 8D herein), for example, an indication of such success (and/or failure) may comprise a success parameter. According to some embodiments, one or more success parameters may be pre-defined. It may be determined, for example, that it is desirable to analyze media items with respect to survey results to determine how desirable a particular media item is (e.g., to a particular audience, group, demographic). In such embodiments, it may be predetermined that survey results comprise a success parameter that should be utilized to analyze and/or process a media item, component, and/or the value proposition object. Other success parameters may include, but are not limited to, sales success parameters, competitive intelligence parameters, and/or third-party analysis parameters. In some embodiments, a value for a particular success metric may be determined. It may be determined, for example, not only that a success metric comprises and indication of whether another company has been successful utilizing a particular media item (e.g., in a particular manner), but what value such parameter has with respect to a particular media item. It may be determined, for example, that ten percent (10%) of the time, the other company has been successful utilizing the media item (e.g., a particular phrase and/or terminology).

In some embodiments, the method 600 may comprise determining media item success metrics, at 616. According to some embodiments, each media item may be scored, ranked, rated, weighted, sorted, grouped, and/or otherwise quantitatively and/or qualitatively analyzed to define, identify, and/or compute or calculate a success metric. In some embodiments, a success metric may be calculated for each possible and/or available media item for a particular component. All known and/or available textual descriptions of a particular service provided by an insurance company's claims department, for example, may be rated based on past success, survey results, and/or other data to determine which of those description as most successful and/or most successful with respect to certain geographies, industries, customer business types, etc. Each description may be assigned a score and/or the descriptions may be ranked. In some embodiments, certain media items and/or characteristics may be determined to be desirable or undesirable regardless of whether utilized in any particular component. It may be determined, for example, that a particular word is advantageous to utilize when describing insurance products, whether such word is utilized with respect to customer results, available service features, industry results, and/or financial data.

According to some embodiments, the method 600 may comprise storing the media item success metrics, at 618. Each analyzed media item, component, and/or value proposition object may be assigned one or more success metrics, for example, such as by storing the success metric in associated with (e.g., in relation to) the respective media item, component, and/or value proposition object. In some embodiments, only a subset of success metric and/or media items, components, and/or value proposition objects may be stored. It may be determined, for example, that only the top five (5) ranked media items for a given component should be stored and/or that only media items having been utilized more than a threshold number of times should be analyzed and/or have success metrics stored with respect thereto.

In some embodiments, the method 600 may comprise providing an indication of the success metrics. The received value proposition object may be evaluated, scored, and/or one or more edits and/or suggestions for edits may be provided. In the case that the value proposition object is yet to be utilized, for example, a user may be advised regarding a likelihood of success of the value proposition object and/or individual components and/or media items (e.g., via a user interface and/or via a value proposition object, such as via the impact palette tools 888c-d of FIG. 8C and/or FIG. 8D herein). Alternate and/or edited media items and/or components may be suggested and/or provided, effectively creating (and/or allowing the user to create) a structured value proposition object.

Referring to FIG. 7, a flow diagram of a method 700 according to some embodiments is shown. In some embodiments, the method 700 may comprise a structured value proposition object creation method which may, for example, be described as a “build engine”. According to some embodiments, the method 700 may be implemented, facilitated, and/or performed by or otherwise associated with any of the systems 100, 200, 500 of FIG. 1, FIG. 2, and/or FIG. 5 herein. In some embodiments, the method 700 may be associated with the method 600 of FIG. 6. The method 700 may, for example, comprise a portion of the method 600.

According to some embodiments, the method 700 may comprise determining a customer identifier, at 702. A product and/or service sales and/or marketing agent, broker, and/or customer (e.g., current or potential) may, for example, provide an indication of an identifier such as via a mobile device and/or via an interface such as an insurance value proposition object creation dashboard (e.g., the dashboard 520 of FIG. 5). In some embodiments, the identifier may be provided in association with and/or as a login credential. In some embodiments, the identifier may be provided as part of and/or with an indication of a product, service, and/or value proposition object (e.g., a draft value proposition object and/or one previously utilized for a similar customer, product, service, etc.). According to some embodiments, the receiving and/or determining of the customer identifier may comprise and/or be associated with a receipt of a request to develop a value proposition object (e.g., from a user operating a mobile and/or remote computing device). The request may, for example, provide an indication of the customer identifier and/or other indications descriptive of a particular sales and/or marketing effort for which a structured value proposition object is desired.

In some embodiments, the method 700 may comprise determining customer data, at 704. Based on the identifier(s) received and/or otherwise determined at 702, for example, information descriptive of the customer may be retrieved from one or more data stores and/or sources. Third-party data services and/or available stored data descriptive of the customer may, in some embodiments, be looked-up, retrieved, and/or accessed utilizing the identifier information. In some embodiments, the customer information may include (but is not limited to) a geography of the customer, a demographic metric of the customer (e.g., age, gender, education level, size of business, gross receipts), an industry in which a business of the customer's operates (or simply an industry associated with a business customer), and/or a sales history of the customer (e.g., other products and/or services owned and/or purchased by the customer).

According to some embodiments, the method 700 may comprise determining value proposition object components, at 706. In some embodiments, a plurality of available components and/or component types may be identified and/or selected. Based on one or more of the identity of the customer and/or some portion of the information descriptive of the customer, for example, a subset of available and/or known components may be selected. According to some embodiments, an arrangement and/or configuration of the selected components may be determined. Based on the industry in which the customer operates, for example, it may be determined that four (4) specific components (e.g., classifications and/or configurations or types of media items) from a total of ten (10) available components should be utilized and/or that the four (4) selected components should be arranged with certain sizing and/or positioning parameters, e.g., on signage, in a presentation file, and/or in an advertisement.

In some embodiments, the method 700 may comprise determining available media items for the components, at 708. Each component may, for example, be associated with (e.g., assigned and/or stored in relation to) a plurality of possible media items. As an example, an industry photograph for fleet vehicle insurance in the transit busing industry (e.g., one of the selected components) may be associated with twenty (20) stored image files tagged as being transit busing industry photos. Other components may similarly be associated with various pluralities of media items. In some embodiments, the media items may be stored in one or more centrally accessible databases, actual and/or virtual (e.g., the “cloud”).

According to some embodiments, the method 700 may comprise determining success metrics for the media items, at 710. Each available media item may, in some embodiments, be associated with (e.g., have a stored indication linking and/or pointing to) a success metric such as a score, rank, and/or rating. In some embodiments, the success metric may be pre-calculated and/or determined and/or pre-stored in association with the media items. In some embodiments, the success metric may be calculated, computed, and/or determined ‘on-the-fly’—e.g., in response to the receiving of the customer identifier at 702 and/or the identification and/or determination of the media items at 708. In some embodiments, the success metrics may comprise predetermined as well as dynamically-calculated and/or determined values. Some media items may have already had success metric defined, for example, while others may have success metrics dynamically defined on an as-needed basis (e.g., upon being identified at 708). According to some embodiments, such as in the case that only a subset of available media items are stored and/or tagged or flagged as “available” based on success metrics (e.g., only the top ten (10) media items in any given category are made available for selection), success metrics may not need to be determined—i.e., it may be assumed that all available media items are already pre-sorted and/or filtered based on levels of success.

In some embodiments, the method 700 may comprise selecting media items, at 712. The particular media items and/or combinations of media items selected for use may be determined in a variety of manners that are or become known and/or practicable. Media items may be automatically and/or randomly selected, for example, to populate various portions of the components or media items may be manually selected from a list of available items by an end-user (e.g., agent, broker, and/or customer). In some embodiments, a listing of the available media items may include indications of the success metrics from 710. The user may then select, for example, media items from a list that ranks, rates, and/or scores (or provides other suggestions) the media items (e.g., in relation to the particular customer and/or sales effort indicated by the end-user at 702). In some embodiments, the media items may be selected based on the success metrics. The highest-ranking and/or scored media item from each category (e.g., for each component and/or potion thereof) may, for example, automatically be selected and/or suggested. In some embodiments, such as in the case that large numbers of media items are available, the success metrics may be utilized to filter the available listings downs to a more manageable size. Where one hundred (100) phrases descriptive of a company's successful insurance premium reduction services are available, for example, only the top three (3) phrases may be presented to a user and/or the top-ranking phrase may be automatically selected on behalf of the user (e.g., with the user having the option to change the selection to one of the other top choices presented). In some embodiments, the media items may be selected randomly and/or in accordance with an adaptive learning process. In some embodiments, the user may be allowed to select from a listing and/or menu of suggested media items and/or components. The user may effectively-override automatic suggestions and/or determinations, for example, and data descriptive of the override (and/or eventual success or failure related thereto) may be analyzed and/or stored. In some embodiments, a user's preference may be included in the determination of which components and/or media items to utilize and/or suggest (the entire list and/or a portion thereof may include one or more user preferred-media items, for example, regardless of rank and/or score). In some embodiments, the selections and/or choices made by a user may be ranked, scored, and/or otherwise provided in a manner that allows the end user to make an informed decision regarding the selected objects. Particular media objects and/or components may be highlighted in different colors such as green, yellow, and red, for example (e.g., indicating ‘good’, ‘not ideal’, and ‘poor’ choices, respectively). In some embodiments, such indications may be provided as a graphical element and/or GUI indicator such as a ‘stop-light’ icon that illuminates an appropriate color tied to a media objects and/or components' ranking (e.g., similar to the impact palette tools 888c-d of FIG. 8C and/or FIG. 8D herein).

According to some embodiments, the method 700 may comprise generating a structured value proposition object, at 714. The components determined at 706 may be populated and/or defined utilizing the media items determined at 712, for example. In some embodiments, the structured value proposition object may be presented as a draft document that may be edited and/or rearranged by the end-user. In some embodiments, the structured value proposition object may be reviewed prior to being provided to a user. Metadata assigned to the selected media items may be utilized, in some embodiments, to allow for a targeted and accordingly more efficient review of the draft structured value proposition object. In some embodiments, the structured value proposition object may be output in electronic and/or hard-copy form. A printer, plotter, fax machine, and/or other hard-copy output device may be utilized, for example, to produce a hard-copy version of the structured value proposition object. In some embodiments, the printer and/or other hard-copy output device may be selected and/or identified based on a proximity to the user (e.g., a local printer). In some embodiments, an electronic file comprising the structured value proposition object may be output to the user. The structured value proposition object may, for example, be output via a display device and/or interface or dashboard, such as via an output device of a portable computing device (e.g., an Apple® iPad™). In some embodiments, such as in the case that the structured value proposition object is output and/or provided in electronic form, the structured value proposition object may comprise one or more interactive components. The user may be allowed and/or enabled to, for example, provide touch screen input designating one or more components and/or media items that are configured to react to the input (e.g., selection of a video clip media item may cause the clip to be played). In some embodiments, the method 700 may comprise providing talking points, notes, background information, and/or other supporting data to the user. The user may be coached, for example, by suggesting certain components and/or media items and providing reasoning descriptive of why such components and/or media items should be utilized (e.g., historic success rates, feedback and/or observations from other users, customers, agents, etc.).

Turning to FIG. 8A, FIG. 8B, FIG. 8C, FIG. 8D, FIG. 8E, and FIG. 8F diagrams of example value proposition objects 860a-f according to some embodiments, are shown. In some embodiments, any or all of the value proposition objects 860a-f may comprise an interface such as a web page, web form, database entry form, API, spreadsheet, table, and/or application or other GUI via which an agent (or other entity) may enter value proposition object data, provide and/or receive value proposition object feedback, and/or construct and/or create a structured value proposition object. The value proposition objects 860a-f may, for example, comprise output from a front-end of a sales and/or marketing program and/or platform programmed and/or otherwise configured to execute, conduct, and/or facilitate any of the various methods 600, 700 of FIG. 6 and/or FIG. 7 and/or portions or combinations thereof described herein. In some embodiments, the value proposition objects 860a-f may be output via a computerized device such as one or more of the user devices 102a-n, 202a-d, 502a-b the third-party devices 106, 206, and/or the controller devices 110, server 210, and/or processing components 510a-e, of FIG. 1, FIG. 2, and/or FIG. 5 herein. According to some embodiments, the value proposition objects 860a-f may comprise one or more hard-copy objects such as printouts, signage, slideshow slides, and/or overhead transparencies. In some embodiments, the value proposition objects 860a-f may be similar in configuration and/or functionality to the value proposition objects 260, 560a-c described in conjunction with FIG. 2 and/or FIG. 5 herein. Components of the value proposition objects 860a-f may, for example, be similar in configuration and/or functionality to any similarly-named and/or numbered components herein. In some embodiments, any or all of the value proposition objects 860a-f may be “structured” as defined herein.

According to some embodiments, and turning specifically to FIG. 8A for example, a first value proposition object 860a may comprise a customer summary component 862a, a customer details component 864a, an accomplishments component 866a, a service advantages component 868a, an industry advantages component 870a, and/or an industry image component 872a. In some embodiments, the first value proposition object 860a may be configured to convey historic accomplishment and/or results that a customer has realized by purchasing products and/or services from a particular company. According to some embodiments, the first value proposition object 860a may comprise a template and/or guide descriptive of an arrangement of the various desired components 862a, 864a, 866a, 868a, 870a, 872a and/or descriptive of and/or providing instructions regarding the type and/or configuration of media items intended for each component 862a, 864a, 866a, 868a, 870a, 872a. In some embodiments, the layout, arrangement, configuration, specific combination of and/or quantity of components 862a, 864a, 866a, 868a, 870a, 872a may comprise a first “structured” value proposition object 860a. According to some embodiments, one or more specific media items may also or alternatively be suggested and/or included. The customer details component 864a may comprise, for example a customer image 864a-1. According to some embodiments, the customer image 864a-1 may be automatically selected from a plurality of available images and/or other media item types, e.g., based on one or more success metrics as described herein.

In some embodiments, and turning specifically to FIG. 8B for example, a second value proposition object 860b may comprise a partnership component 874b, a scoreboard component 876b, a legal component 878b, a future results component 880b, a future company advantages component 882b, a partner advantages component 884b, and/or a partner image component 886b. In some embodiments, the second value proposition object 860b may be configured to convey future, predicted, and/or desired accomplishments and/or results that a customer may realize by purchasing products and/or services from the particular company. According to some embodiments, the second value proposition object 860b may comprise a template and/or guide descriptive of an arrangement of the various desired components 860b, 874b, 876b, 878b, 880b, 882b, 884b, 886b and/or descriptive of and/or providing instructions regarding the type and/or configuration of media items intended for each component 860b, 874b, 876b, 878b, 880b, 882b, 884b, 886b. In some embodiments, the layout, arrangement, configuration, specific combination of and/or quantity of components 860b, 874b, 876b, 878b, 880b, 882b, 884b, 886b may comprise a second “structured” value proposition object 860b. In some embodiments, the first and second structured value proposition objects 860a-b may, together, comprise multiple sections and/or portions of a single structured value proposition object (not separately depicted). In some embodiments, the scoreboard component 876b may comprise a plurality of place holders 876b-1 for ranked media items. A particular media item type descriptive of product and/or service metrics, for example, may be ranked and the top five (5) metrics (e.g., based on degree of success and/or performance and/or based on an expected weight with respect to marketing effectiveness) may be populated in the place holders 876b-1.

According to some embodiments, and turning specifically to FIG. 8C for example, a third value proposition object 860c may comprise a customer summary component 862c, a customer details component 864c, an accomplishments component 866c, an industry image component 872c, and/or a legal component 878c. In some embodiments, the third value proposition object 860c may be configured to convey past performance and/or accomplishments or results that a particular customer, agent, and/or brokerage (e.g., “Transco”) may have realized by purchasing products and/or services from the particular company. In some embodiments, one or more specific media items may be populated and/or suggested as part of the third value proposition object 860c. In the case of “Transco”, for example, each component 862c, 864c, 866c, 872c, 878c may be automatically populated, such as in response to a request for sales and/or marketing materials (e.g., the third structured value proposition object 860c) that identifies the customer/potential customer/client “Transco”. The customer details component 864c may, for example, be populated with a particular metric 864c-1 such as the ‘number of regional meetings held’ metric shown (the value of the metric being five (5) in the example of FIG. 8C). The particular metric 864c-1 may be selected and/or suggested, according to some embodiments, based on how successful usage of the particular metric 864c-1 has been with respect to “Transco” and/or other customers/potential customers in the same industry and/or region as “Transco”.

According to some embodiments, the third value proposition object 860c may comprise an impact palette tool 888c. The impact palette tool 888c may comprise, for example, a GUI object and/or input device component that is responsive to user input in selection of one of a plurality of available informational “painting” colors such as a first color “A”, a second color “B”, and a third color “C”, as depicted. In some embodiments, such as shown for non-limiting exemplary purposes only, the impact palette tool 888c may be configured to resemble a traffic light, wherein the first color “A” may comprise red, the second color “B” may comprise yellow (or orange), and the third color “C” may comprise green. According to some embodiments, the impact palette tool 888c may be utilized as and/or comprise a touch-screen component that is responsive to user input (e.g., touch input) defining a section of one of the informational painting colors. A user may select (and a processing device providing the third value proposition object 860c may receive an indication and/or associated input of), for example, the first color “A” (e.g., red), which becomes the active painting color. In some embodiments, the user may utilize the active painting color to provide information such as feedback and/or options regarding any or all of the components 862c, 864c, 866c, 872c, 878c (and/or particular media objects thereof). In the case that the user feels that the customer summary component 862c is not desirable and/or in the case that the user has information that the customer summary component 862c has not been successful, the user may touch (and/or otherwise select) one or more impact areas 888c-1 through 888c-8, such as a first impact area 888c-1, causing the first impact area 888c-1 to reflect and/or become associated with the first color “A” (e.g., red”). Similarly, in the case that the user desires to indicate that the particular metric 864c-1 of the customer details component 864c has been received favorably by a customer (for example), the user may select and/or activate the third color “C” (e.g., green) and select a second sub impact area 888c-2b (e.g., of a second impact area 888c-2), causing the second sub impact area 888c-2b (e.g., of the second impact area 888c-2) to display and/or otherwise indicate the third color “C”. It should be understood that while specific colors and configurations associated with the impact palette tool 888c are described herein, other indicators and/or configurations that allow a user to provide simple and easily-understood media object feedback and/or information (e.g., indications of success parameters) may be utilized without deviating from the scope of some embodiments.

In some embodiments, and turning specifically to FIG. 8D for example, a fourth value proposition object 860d may comprise a customer summary component 862d, a customer details component 864d, an industry image component 872d, a legal component 878d, and/or a future results component 880d. In some embodiments, the fourth value proposition object 860d may be configured to convey a combination of past performance and/or accomplishments or results with future and/or predicted results and/or goals that a particular customer, agent, and/or brokerage (e.g., “Transco”) may have realized/realize by purchasing products and/or services from the particular company. In some embodiments, certain components 862d, 864d, 872d, 878d, 880d may be highlighted and/or flagged (not explicitly shown in FIG. 8D) to indicate that such components 862d, 864d, 872d, 878d, 880d have already been reviewed and/or authorized. The legal component 878d may be grayed-out and/or otherwise flagged to indicate to a legal review team, personnel, and/or device that the legal component 878d has already passed scrutiny and that a targeted review should accordingly concentrate on the other components 862d, 864d, 872d, 880d. In some embodiments, the industry image component 872d and/or a media item such as an image thereof may be flagged/highlighted/annotated to indicate that copyrights in the image have (or have not) been acquired—e.g., indicating that no action (or some action) should be taken with respect thereto. In some embodiments, the fourth value proposition object 860d may comprise an impact palette tool 888d and/or respective (or related) impact areas 888d-1 through 888d-8 (and/or sub-areas). As described herein, such features may be utilized to associate and/or assign a score, rating, and/or success impact level to one or more media objects and/or components 862d, 864d, 872d, 880d.

According to some embodiments, and turning specifically to FIG. 8E for example, a fifth value proposition object 860e may comprise a legal component 878e, a partner advantages component 884e, partner components 890e (e.g., a partner heading component 890e-1 and/or a partnership identification component 890e-2), a value proposition identifier component 892e, and/or an value proposition details component 894e.

In some embodiments, and turning specifically to FIG. 8F for example, a sixth value proposition object 860f may comprise a legal component 878f, partner components 890f (e.g., a partner heading component 890f-1 and/or a partnership identification component 890f-2), a value proposition identifier component 892f, and/or a value proposition details component 894f.

While various components of the value proposition objects 860a-f of FIG. 8A, FIG. 8B, FIG. 8C, FIG. 8D, FIG. 8E, and FIG. 8F have been described with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments

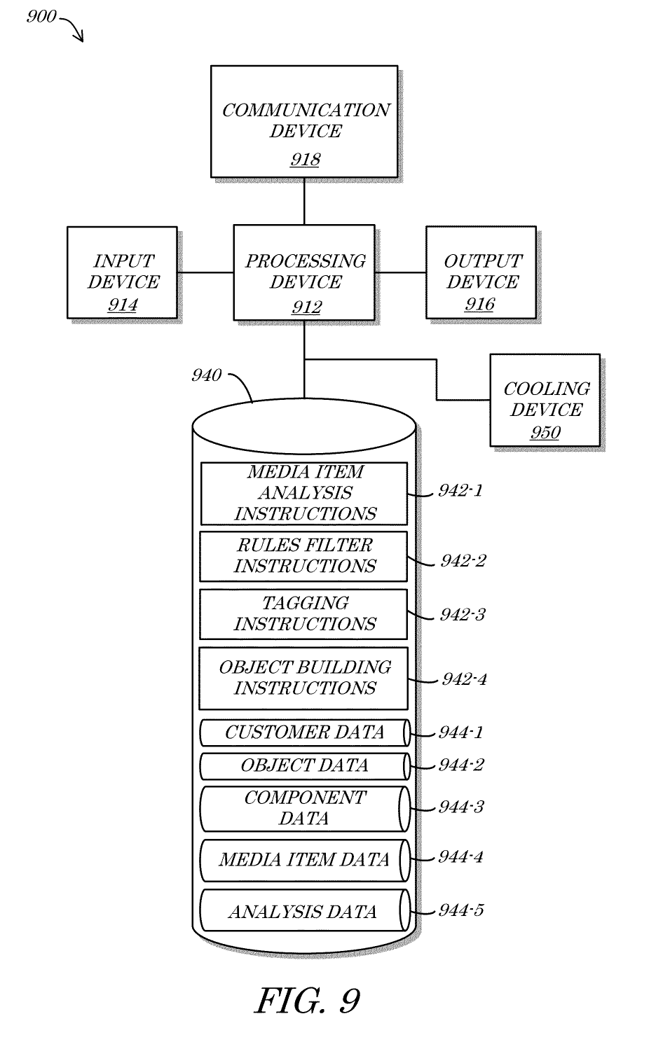

Turning to FIG. 9, a block diagram of an apparatus 900 according to some embodiments is shown. In some embodiments, the apparatus 900 may be similar in configuration and/or functionality to any of the user devices 102a-n, 202a-d, 502a-b the third-party devices 106, 206, and/or the controller devices 110, server 210, and/or processing components 510a-e, of FIG. 1, FIG. 2, and/or FIG. 5 herein. The apparatus 900 may, for example, execute, process, facilitate, and/or otherwise be associated with the methods 600, 700 of FIG. 6 and/or FIG. 7 herein. In some embodiments, the apparatus 900 may comprise a processing device 912, an input device 914, an output device 916, a communication device 918, a memory device 940, and/or a cooling device 950. According to some embodiments, any or all of the components 912, 914, 916, 918, 940, 950 of the apparatus 900 may be similar in configuration and/or functionality to any similarly named and/or numbered components described herein. Fewer or more components 912, 914, 916, 918, 940, 950 and/or various configurations of the components 912, 914, 916, 918, 940, 950 may be included in the apparatus 900 without deviating from the scope of embodiments described herein.

According to some embodiments, the processor 912 may be or include any type, quantity, and/or configuration of processor that is or becomes known. The processor 912 may comprise, for example, an Intel® IXP 2800 network processor or an Intel® XEON™ Processor coupled with an Intel® E7501 chipset. In some embodiments, the processor 912 may comprise multiple inter-connected processors, microprocessors, and/or micro-engines. According to some embodiments, the processor 912 (and/or the apparatus 900 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 900 comprises a server such as a blade server, necessary power may be supplied via a standard AC outlet, power strip, surge protector, and/or Uninterruptible Power Supply (UPS) device.

In some embodiments, the input device 914 and/or the output device 916 are communicatively coupled to the processor 912 (e.g., via wired and/or wireless connections and/or pathways) and they may generally comprise any types or configurations of input and output components and/or devices that are or become known, respectively. The input device 914 may comprise, for example, a keyboard that allows an operator of the apparatus 900 to interface with the apparatus 900 (e.g., by an marketing, sales, and/or insurance agent, such as to rate, evaluate, and/or construct one or more value proposition objects as described herein). In some embodiments, the input device 914 may comprise a sensor configured to provide value proposition object and/or media item information to the apparatus 900 and/or the processor 912. The output device 916 may, according to some embodiments, comprise a display screen and/or other practicable output component and/or device. The output device 916 may, for example, provide a structured value proposition object to a potential client (e.g., via a website) and/or to a sales agent (e.g., via a computer and/or tablet workstation). According to some embodiments, the input device 914 and/or the output device 916 may comprise and/or be embodied in a single device such as a touch-screen monitor.

In some embodiments, the communication device 918 may comprise any type or configuration of communication device that is or becomes known or practicable. The communication device 918 may, for example, comprise a Network Interface Card (NIC), a telephonic device, a cellular network device, a router, a hub, a modem, and/or a communications port or cable. In some embodiments, the communication device 918 may be coupled to provide data to a client device, such as in the case that the apparatus 900 is utilized to develop a structured value proposition object. The communication device 918 may, for example, comprise a cellular telephone network transmission device that sends signals indicative of a value proposition object, object components, and/or associated media items to a handheld, mobile, and/or telephone device. According to some embodiments, the communication device 918 may also or alternatively be coupled to the processor 912. In some embodiments, the communication device 918 may comprise an IR, RF, Bluetooth™, Near-Field Communication (NFC), and/or Wi-Fi® network device coupled to facilitate communications between the processor 912 and another device (such as a client device and/or a third-party device, not shown in FIG. 9).

The memory device 940 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 940 may, according to some embodiments, store one or more of media item analysis instructions 942-1, rules filter instructions 942-2, tagging instructions 942-3, object building instructions 942-4, customer data 944-1, object data 944-2, component data 944-3, media item data 944-4, and/or analysis data 944-5. In some embodiments, the media item analysis instructions 942-1, rules filter instructions 942-2, tagging instructions 942-3, object building instructions 942-4 may be utilized by the processor 912 to provide output information via the output device 916 and/or the communication device 918.

According to some embodiments, the media item analysis instructions 942-1 may be operable to cause the processor 912 to process the customer data 944-1, object data 944-2, component data 944-3, media item data 944-4, and/or analysis data 944-5 in accordance with embodiments as described herein. Customer data 944-1, object data 944-2, component data 944-3, media item data 944-4, and/or analysis data 944-5 received via the input device 914 and/or the communication device 918 may, for example, be analyzed, sorted, filtered, decoded, decompressed, ranked, scored, plotted, and/or otherwise processed by the processor 912 in accordance with the media item analysis instructions 942-1. In some embodiments, customer data 944-1, object data 944-2, component data 944-3, media item data 944-4, and/or analysis data 944-5 may be fed by the processor 912 through one or more mathematical and/or statistical formulas and/or models in accordance with the media item analysis instructions 942-1 to determine one or more success parameters and/or metrics descriptive of each of a plurality of media items, as described herein.

In some embodiments, the rules filter instructions 942-2 may be operable to cause the processor 912 to process the customer data 944-1, object data 944-2, component data 944-3, media item data 944-4, and/or analysis data 944-5 in accordance with embodiments as described herein. Customer data 944-1, object data 944-2, component data 944-3, media item data 944-4, and/or analysis data 944-5 received via the input device 914 and/or the communication device 918 may, for example, be analyzed, sorted, filtered, decoded, decompressed, ranked, scored, plotted, and/or otherwise processed by the processor 912 in accordance with the rules filter instructions 942-2. In some embodiments, customer data 944-1, object data 944-2, component data 944-3, media item data 944-4, and/or analysis data 944-5 may be fed by the processor 912 through one or more mathematical and/or statistical formulas and/or models in accordance with the rules filter instructions 942-2 to filter, edit, flag, tag, and/or otherwise apply one or more stored rules to process media items, as described herein.

According to some embodiments, the tagging instructions 942-3 may be operable to cause the processor 912 to process the customer data 944-1, object data 944-2, component data 944-3, media item data 944-4, and/or analysis data 944-5 in accordance with embodiments as described herein. Customer data 944-1, object data 944-2, component data 944-3, media item data 944-4, and/or analysis data 944-5 received via the input device 914 and/or the communication device 918 may, for example, be analyzed, sorted, filtered, decoded, decompressed, ranked, scored, plotted, and/or otherwise processed by the processor 912 in accordance with the tagging instructions 942-3. In some embodiments, customer data 944-1, object data 944-2, component data 944-3, media item data 944-4, and/or analysis data 944-5 may be fed by the processor 912 through one or more mathematical and/or statistical formulas and/or models in accordance with the tagging instructions 942-3 to tag media items with data descriptive of a usage of the media items (e.g., with customer, industry, geographic, and/or demographic data), as described herein.

In some embodiments, the object building instructions 942-4 may be operable to cause the processor 912 to process the customer data 944-1, object data 944-2, component data 944-3, media item data 944-4, and/or analysis data 944-5 in accordance with embodiments as described herein. Customer data 944-1, object data 944-2, component data 944-3, media item data 944-4, and/or analysis data 944-5 received via the input device 914 and/or the communication device 918 may, for example, be analyzed, sorted, filtered, decoded, decompressed, ranked, scored, plotted, and/or otherwise processed by the processor 912 in accordance with the object building instructions 942-4. In some embodiments, customer data 944-1, object data 944-2, component data 944-3, media item data 944-4, and/or analysis data 944-5 may be fed by the processor 912 through one or more mathematical and/or statistical formulas and/or models in accordance with the object building instructions 942-4 to evaluate, construct, print, generate, and/or otherwise determine and/or provide one or more structured value proposition objects (and/or portions thereof), as described herein.

In some embodiments, the apparatus 900 may function as a computer terminal and/or server of an insurance and/or underwriting company, for example, that is utilized to process value proposition objects and/or create structured value proposition objects as described herein. In some embodiments, the apparatus 900 may comprise a web server and/or other portal (e.g., an Interactive Voice Response Unit (IVRU)) that provides structured value proposition objects to support sales and/or marketing efforts.

In some embodiments, the apparatus 900 may comprise the cooling device 950. According to some embodiments, the cooling device 950 may be coupled (physically, thermally, and/or electrically) to the processor 912 and/or to the memory device 940. The cooling device 950 may, for example, comprise a fan, heat sink, heat pipe, radiator, cold plate, and/or other cooling component or device or combinations thereof, configured to remove heat from portions or components of the apparatus 900.

Any or all of the exemplary instructions and data types described herein and other practicable types of data may be stored in any number, type, and/or configuration of memory devices that is or becomes known. The memory device 940 may, for example, comprise one or more data tables or files, databases, table spaces, registers, and/or other storage structures. In some embodiments, multiple databases and/or storage structures (and/or multiple memory devices 940) may be utilized to store information associated with the apparatus 900. According to some embodiments, the memory device 940 may be incorporated into and/or otherwise coupled to the apparatus 900 (e.g., as shown) or may simply be accessible to the apparatus 900 (e.g., externally located and/or situated).

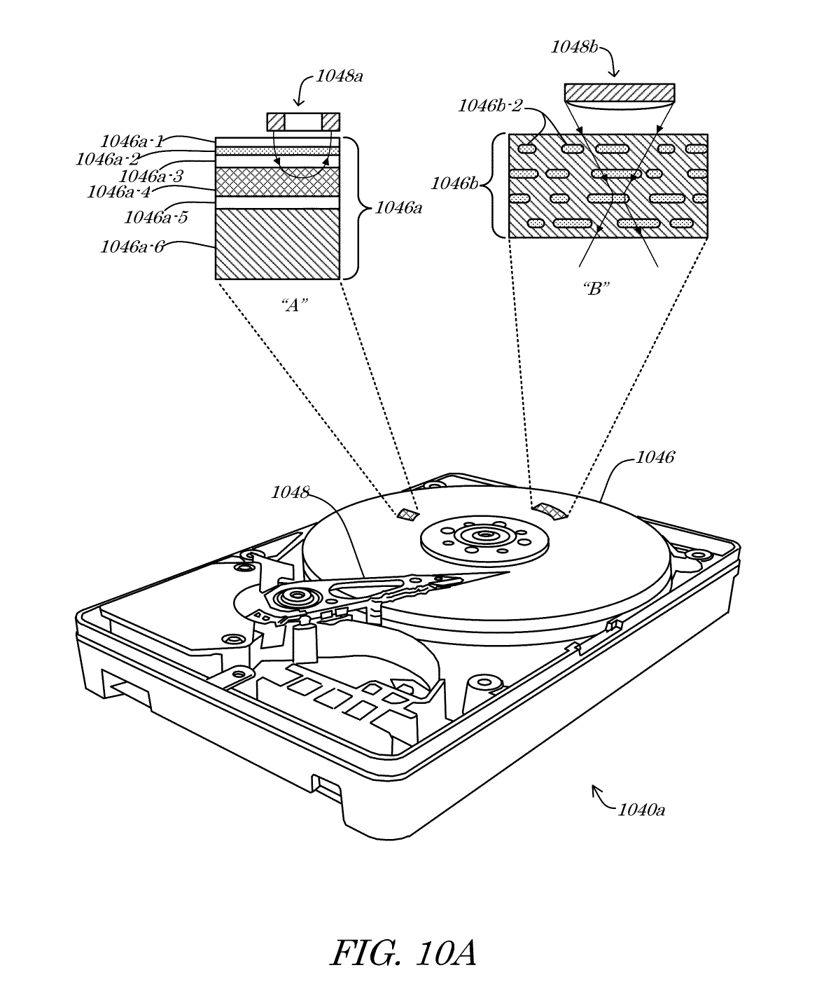

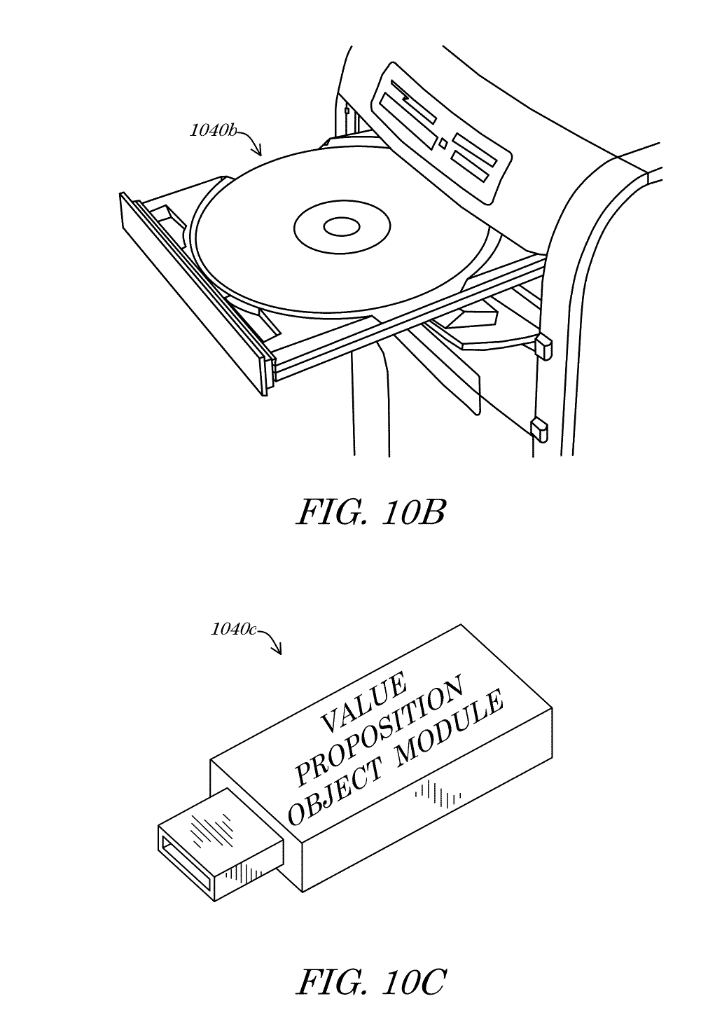

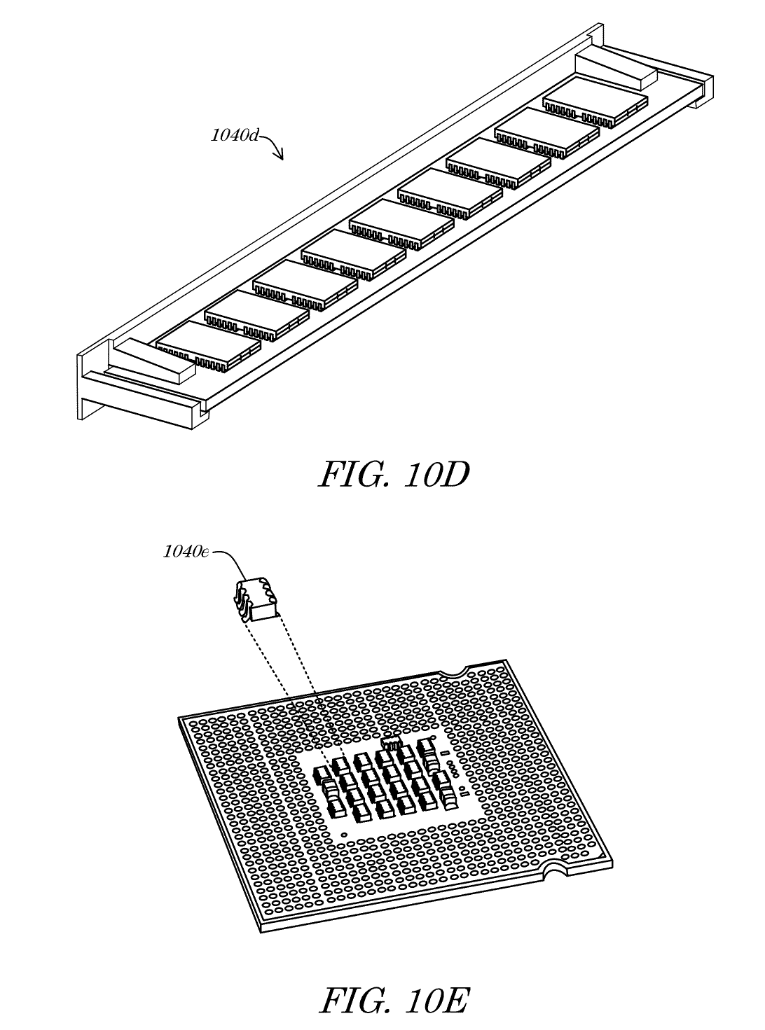

Referring to FIG. 10A, FIG. 10B, FIG. 10C, FIG. 10D, and FIG. 10E, perspective diagrams of exemplary data storage devices 1040a-e according to some embodiments are shown. The data storage devices 1040a-e may, for example, be utilized to store instructions and/or data such as the media item analysis instructions 942-1, rules filter instructions 942-2, tagging instructions 942-3, object building instructions 942-4, customer data 944-1, object data 944-2, component data 944-3, media item data 944-4, and/or analysis data 944-5, each of which is described in reference to FIG. 9 herein. In some embodiments, instructions stored on the data storage devices 1040a-e may, when executed by a processor, cause the implementation of and/or facilitate the methods 600, 700 of FIG. 6 and/or FIG. 7 herein (or any portions or combinations thereof).

According to some embodiments, the first data storage device 1040a may comprise one or more various types of internal and/or external hard drives. The first data storage device 1040a may, for example, comprise a data storage medium 1046 that is read, interrogated, and/or otherwise communicatively coupled to and/or via a disk reading device 1048. In some embodiments, the first data storage device 1040a and/or the data storage medium 1046 may be configured to store information utilizing one or more magnetic, inductive, and/or optical means (e.g., magnetic, inductive, and/or optical-encoding). The data storage medium 1046, depicted as a first data storage medium 1046a for example (e.g., breakout cross-section “A”), may comprise one or more of a polymer layer 1046a-1, a magnetic data storage layer 1046a-2, a non-magnetic layer 1046a-3, a magnetic base layer 1046a-4, a contact layer 1046a-5, and/or a substrate layer 1046a-6. According to some embodiments, a magnetic read head 1046a may be coupled and/or disposed to read data from the magnetic data storage layer 1046a-2.

In some embodiments, the data storage medium 1046, depicted as a second data storage medium 1046b for example (e.g., breakout cross-section “B”), may comprise a plurality of data points 1046b-2 disposed with the second data storage medium 1046b. The data points 1046b-2 may, in some embodiments, be read and/or otherwise interfaced with via a laser-enabled read head 1048b disposed and/or coupled to direct a laser beam (and/or other optical signal) through the second data storage medium 1046b.

According to some embodiments, the second data storage device 1040b may comprise a CD, CD-ROM, DVD, Blu-Ray™ Disc, and/or other type of optically-encoded disk and/or other storage medium that is or becomes know or practicable. In some embodiments, the third data storage device 1040c may comprise a USB keyfob, dongle, and/or other type of flash memory data storage device that is or becomes know or practicable. In some embodiments, the fourth data storage device 1040d may comprise RAM of any type, quantity, and/or configuration that is or becomes practicable and/or desirable. In some embodiments, the fourth data storage device 1040d may comprise an off-chip cache such as a Level 2 (L2) cache memory device. According to some embodiments, the fifth data storage device 1040e may comprise an on-chip memory device such as a Level 1 (L1) cache memory device.

The data storage devices 1040a-e may generally store program instructions, code, and/or modules that, when executed by a processing device cause a particular machine to function in accordance with one or more embodiments described herein. The data storage devices 1040a-e depicted in FIG. 10A, FIG. 10B, FIG. 10C, FIG. 10D, and FIG. 10E are representative of a class and/or subset of computer-readable media that are defined herein as “computer-readable memory” (e.g., non-transitory memory devices as opposed to transmission devices or media).

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a Personal Computer (PC), a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A system for providing dynamic graphical recommendations for utilizing media items in an electronically networked environment, comprising:
an electronic processing device;
a graphical user dashboard operable to display graphical output to a user, the graphical user dashboard being generated by the electronic processing device; and
a non-transitory computer-readable memory storing (i) media item data for a plurality of media items and (ii) graphical user dashboard generation instructions, wherein the instructions, when executed by the electronic processing device, result in:
receiving, from a user and by the graphical user dashboard, an indication of a value proposition object, the value proposition object comprising a plurality of components, each component comprising at least one media item;
determining, by the electronic processing device and for each of the at least one media items of each component, a score, the score being based on the media item data, the media item data comprising historic sales data related to the particular at least one media item;
aggregating, by the electronic processing device and for each component, the scores for the at least one media item thereof;
displaying, by the graphical user dashboard and to the user, an interactive version of the value proposition object comprising, for each component of the plurality components, a graphical element providing a graphical depiction of the aggregated score for the component; and
receiving, by the graphical user dashboard and from the user, and via one of the displayed graphical elements, input relating to the component for which the one of the graphical elements is displayed.

2. The system of claim 1, wherein the graphical elements comprise a color-coded highlighting of each component.

3. The system of claim 1, wherein the graphical elements comprise GUI indicators of stop-lights showing, for each component, one of a red, yellow, or green score depiction.

4. The system of claim 1, wherein the graphical user dashboard is output via a display device of a tablet computer, the display device comprising a touch-sensitive display device.

5. The system of claim 1, wherein the plurality of components comprise three or more of: (i) a business comprehension component; (ii) an industry comprehension component; (iii) an accomplishments component; (iv) an advantages component; (v) a partnership component; (vi) a performance data component; (vii) a prospective growth component; (viii) a prospective value component; and (ix) an agent relationship component.

6. The system of claim 1, wherein the non-transitory computer-readable memory further stores, for each of the at least one media items: (i) a text paragraph; (ii) a text phrase; (iii) a word; (iv) a grammatical structure; (v) a graphic; (vi) a picture; (vii) a video file; and (viii) an audio file.

7. The system of claim 1, further comprising:
modifying, based on the received input relating to the component for which the one of the graphical elements is displayed, the aggregated score for the component.

8. The system of claim 1, wherein the received input relating to the component for which the one of the graphical elements is displayed comprises at least one of: (i) competitive intelligence data; (ii) weather data; and (iii) survey data.
